(19) United States
(12) Patent Application Publication
(10) Pub. No.: US 2003/0141820 A1
(43) Pub. Date: Jul. 31, 2003

(54) Method and apparatus for substrate processing

(75) Inventors: John M. White, Hayward, CA (US); Kam S. Law, Union City, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 10/066,131

(22) Filed: Jan. 30, 2002

(51) Int. Cl. H01J 7/24

(52) U.S. Cl. 315/111.21; 315/111.81

(57) ABSTRACT

Embodiments of the invention provide methods and apparatus to process substrates such as flat panel displays, solar panels, etc. In one aspect, the apparatus provides external toroidal plasma generation to perform substrate processes such as deposition and etching of rectangular-shaped substrates. In another aspect, the apparatus provides external toroidal plasma generation to perform chamber cleaning by flowing plasma of a process gas such as argon through a toroidal plasma current path that includes a processing region to be cleaned, introducing a cleaning gas such as fluorine into the processing region from a showerhead apparatus, and cleaning the processing region. In still another aspect, a toroidal plasma loop is shaped by a plasma shaping apparatus to direct the plasma across a processing region within the apparatus to improve process uniformity.

### BACKGROUND OF THE INVENTION

1. Field of the Invention

The invention relates to a method and apparatus for substrate processing. More specifically, the invention relates to a method and apparatus for performing processing steps such as deposition and/or etching of a substrate and/or process chamber cleaning.

2. Background of the Related Art

In the fabrication of integrated flat panel displays (FPD) and solar cells, electrically functional devices are formed by depositing and removing multiple layers of conducting, semiconducting, and dielectric materials from a substrate. Processing techniques used to create FPDs and solar cells can include chemical vapor deposition (CVD), plasma-enhanced chemical vapor deposition (PECVD), physical vapor deposition (PVD), etching, and the like.

Plasma processing is particularly well suited for the production of integrated flat panels because of the relatively lower processing temperatures required to deposit films having good film quality. Generally, plasma-processing applications can be characterized by the kinetic energy of the ions in plasma, and by the level of direct exposure of the substrate or film being processed to the plasma. For example, applications sensitive to substrate or film damage generally require low-kinetic energy ions from the plasma, while applications such as anisotropic etching of silicon dioxide require ions with higher kinetic energy.

The basic methods for plasma processing include DC discharge, RF discharge, and microwave discharge. One example of a plasma-processing chamber places the substrate on a substrate support having an electrode opposite a planar electrode. The planar electrode is used to couple high frequency power to the electrode to form a plasma between the electrode and the planar electrode. However, some devices or materials are not compatible with this type of plasma formation particularly because the plasma includes high-energy photons that cause undesirable substrate heating. To overcome this issue, another approach to plasma processing generates plasma in a remote location i.e., in a remote plasma source, (RPS) and couples the plasma to the processing chamber. Various types of remote plasma generators have been developed including magnetron sources coupled to a cavity, microwave irradiation directed at the plasma precursor, and others. Unfortunately, a portion of the energy within the plasma is lost to the conduits used to transport the plasma from the remote location which may affect the substrate processing efficiency.

Conventional inductively coupled RF plasma sources are often used because they can generate large-area plasmas and generally have a higher processing rate than capacitively coupled sources and most remote plasma sources. In principle, inductively coupled plasma systems permit generation of high-density plasma in one portion of the processing chamber (e.g., above the substrate being processed) and sufficiently far away that the substrate is not directly exposed to the plasma.

External toroidal plasma systems have been developed to further shield the substrate from plasma generation, provide a more uniform plasma across the substrate surface, and to overcome the disadvantages of the conventional inductively coupled plasma sources. One such system is described in U.S. patent application Ser. No. 09/638,075 entitled “Externally Excited Toroidal Plasma Source” filed Aug. 11, 2000. In this case, plasma is created within one or more conduits that extend externally from and are coupled to a processing region within a processing chamber. The conduits and processing region define a closed plasma loop (e.g., toroidal) path. The plasma and plasma currents are bound within the path by plasma sheaths formed at the various conductive surfaces that include the substrate and the adjacent walls of the processing region and the inner conduit surfaces.

Conventional toroidal plasma processing systems used for processes such as etching have proven effective on smaller size round substrates up to about 300 mm. Generally, the plasma current flow through the toroidal processing region is constrained between an upper chamber surface sheath and the substrate to cover more substrate surface area, thereby minimizing the amount of plasma needed and maximizing the plasma energy used. However, the efficient use of toroidal plasma processing systems to process substrates is detrimentally affected by the increasing size of substrates. The problems associated with toroidal plasma processing systems are particularly dramatic on rectangular shaped substrates having surface areas approaching a square meter, such as FPDs, solar panels, and the like. As substrates increase in size, the plasma current path distance and surface area coverage increases resulting in an increase in plasma current resistance. In addition, the increasing size of substrates adversely affects plasma density uniformity. As the substrate size is increased, plasma density uniformity becomes increasingly difficult to maintain causing processing problems such as non-uniform deposition and etching. For example, deposition may be unacceptably thick or thin on the edges and near the corners effectively reducing the usable substrate surface area.

Over time, process cycles (e.g., deposition and etching) leave a residue on chamber components. In some cases, this residue can interfere with the process being performed in the chamber and result in defective substrates. Accordingly, process chambers require periodic cleaning to ensure proper operation. One common way to accomplish this is to use a plasma-excited gas mixture that reacts with the residue, turning it into a volatile compound that can then be flushed from the system in preparation for the next substrate process. Often, a cleaning plasma is provided by biasing a pair of electrodes (typically, a showerhead and a substrate support member) to capacitively couple energy into a processing region of the processing chamber. Unfortunately, under direct exposure to the plasma, the showerhead and substrate support member can become damaged by the ions of the plasma. Damage to the chamber components often reduces subsequent processing effectiveness and requires additional processing chamber maintenance, thereby increasing production cost.

Because of this issue, it has recently become more common to remotely-excite the cleaning gas in a volume that is physically removed from the processing electrodes. However, this practice comes with its own limitations as the excited reactants are remotely generated they must therefore be transported some distance to the processing volume to be effective in cleaning the residue from the processing system. This transport distance can be minimized as much as possible but still some of the reactants will become de-activated due to the inevitable wall interactions they unavoidably undergo along the way. Therefore, there is a need for method and apparatus to provide uniform plasma processing, including efficient cleaning, within a substrate processing system adapted to process large area substrates.

### SUMMARY OF THE INVENTION

Aspects of the invention generally provide an apparatus and method to perform plasma processing such as deposition, etching, and chamber cleaning. In one embodiment, a chamber comprises a body, a bottom, a lid, and a substrate support member disposed within the chamber. The lid, substrate support, and body define a processing region coupled to a pump adapted to maintain gas pressure therein. The chamber further comprises a RF source provided to excite plasma therein. An external structure defines a first toroidal plasma current path extending through the processing region and at least one plasma shaping apparatus is disposed within the first toroidal plasma current path to direct plasma distribution within the processing region.

In another embodiment, the invention provides a plasma generating system, comprising a first hollow member defining a first plasma current path and a second hollow member defining a second plasma current path disposed substantially crosswise with respect to the first hollow member. A first electromagnetic source is disposed along a least a portion of the first hollow member and adapted to produce a first magnetic field within the first hollow member. A second electromagnetic source is disposed along a least a portion of the second hollow member and adapted to produce a second magnetic field within the second hollow member. The plasma generating system also includes a first plasma shaping apparatus disposed on at least one end of the first hollow member, and a second plasma shaping apparatus disposed on at least one end of the second hollow member.

In another embodiment, the invention provides a plasma shaping apparatus, comprising a body, including an inner surface defining a symmetrical opening to allow plasma current flow therethrough where the opening has a cross section of varying dimensions to affect the density distribution of plasma current flowing through the opening.

In another embodiment, the invention provides a method of substrate processing, comprising flowing a first gas into a first plasma current path defined by a first hollow member located external to a processing region, applying power to a first antenna adjacent the hollow member in order to inductively couple energy into the first plasma current path to provide a first plasma current and to generate a first plasma from the first gas. The method further includes flowing the first plasma current through a processing region adjacent a substrate and through another end of the first hollow member to define a first closed plasma current path. The method further includes flowing a process gas through a showerhead into the processing region and generating a plasma of the process gas adjacent the substrate using the plasma of the first gas.

### BRIEF DESCRIPTION OF THE DRAWINGS

So that the manner in which the above recited features, advantages and aspects of the invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a plan-view of a large-area plasma-processing tool.

FIG. 2 is a top perspective view of a processing chamber of the large-area plasma-processing tool of FIG. 1.

FIG. 3 is a top view illustrating a processing chamber of the large-area plasma-processing tool of FIG. 1.

FIG. 4 is side view of illustrating a processing chamber of the large-area plasma-processing tool of FIG. 1.

FIG. 5 is a cutaway side view illustrating a processing chamber of the large-area plasma-processing tool of FIG. 1.

FIGS. 6A and 6B are top and side views respectively illustrating one type of coil antenna arrangement.

FIGS. 7A and 7B are top and side views respectively illustrating one type of coil antenna arrangement.

FIG. 8 is a side view of a plasma shaping apparatus.

FIG. 9 is a side view of a plasma shaping apparatus.

FIG. 10 is a side view of a plasma shaping apparatus.

FIG. 11 is a top view of a processing chamber of the large-area plasma-processing tool of FIG. 1 including four magnetic plasma shaping apparatuses.

FIGS. 12A and 12B are top and side views illustrating one embodiment of an electromagnetic plasma shaping apparatus of FIG. 11.

FIGS. 13A and 13B are top and side views illustrating one embodiment of an electromagnetic plasma shaping apparatus of FIG. 11.

FIGS. 14A and 14B are top and side views illustrating one embodiment of a magnetic plasma shaping apparatus of FIG. 11.

FIGS. 15A and 15B are top and side views illustrating one embodiment of a magnetic plasma shaping apparatus of FIG. 11.

FIGS. 16A and 16B are top and side views illustrating one embodiment of a magnetic plasma shaping apparatus of FIG. 11.

FIGS. 17A and 17B are top and side views illustrating one embodiment of a magnetic plasma shaping apparatus of FIG. 11.

FIGS. 18A and 18B are a top and side view illustrating one embodiment of a magnetic plasma shaping apparatus of FIG. 11.

FIGS. 19A and 19B are top and side views illustrating one embodiment of a magnetic plasma shaping apparatus of FIG. 11.

FIGS. 20A and 20B are top and side views illustrating one embodiment of a magnetic plasma shaping apparatus of FIG. 11.

FIGS. 21A and 21B are top and side views illustrating one embodiment of a magnetic plasma shaping apparatus of FIG. 11.

### DETAILED DESCRIPTION OF THE PREFERRED EMBODIMENT

Aspects of the invention have particular advantages in a multi-chamber processing system, also known as a cluster tool, which is commonly used in the semiconductor industry. Additionally, aspects of the invention are and well suited for supporting the toroidal substrate plasma-processing chamber described herein. A cluster tool is a modular system comprising multiple chambers that perform various functions including substrate heating, center-finding and orientation, annealing, deposition, etching, and the like. The multiple chambers are mounted to a central transfer chamber which houses a robot adapted to shuttle substrates between the chambers. The transfer chamber is typically maintained at a vacuum condition and provides an intermediate stage for shuttling substrates from one chamber to another and/or to a load lock chamber positioned at a front end of the cluster tool.

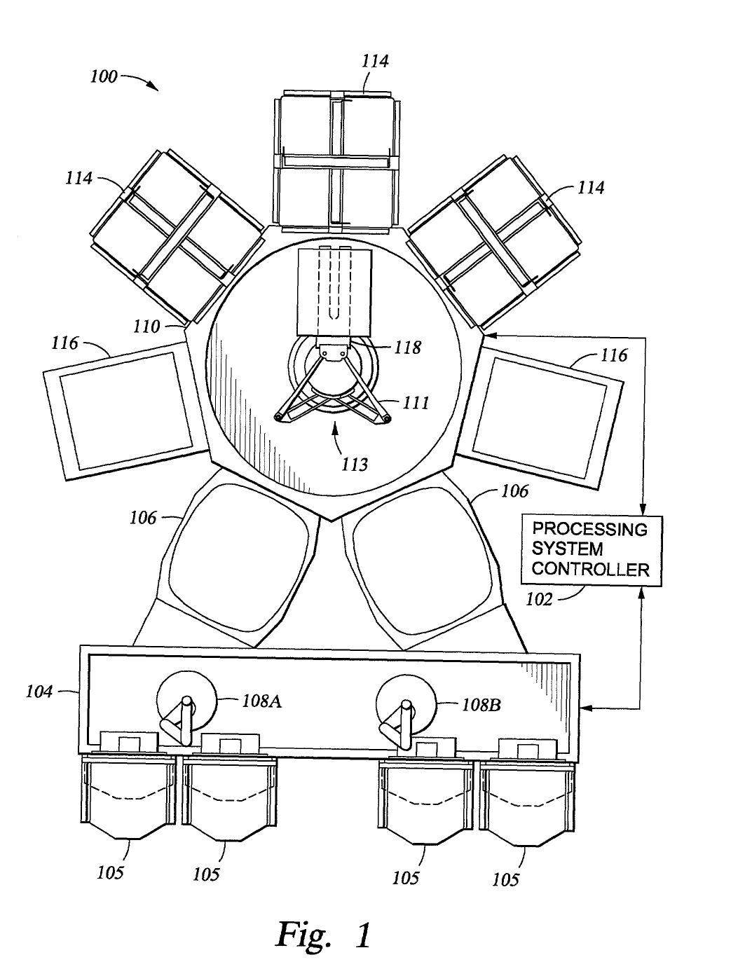

FIG. 1 is a plan view of a processing system 100 for semiconductor processing. The processing system 100 generally comprises a plurality of chambers and robots and is preferably equipped with a process system controller 102 programmed to carry out the various processing methods performed in the processing system 100. A front-end environment 104 is shown positioned in selective communication with a pair of load lock chambers 106. Pod loaders 108A-B disposed in the front-end environment 104 are capable of linear, rotational, and vertical movement to shuttle substrates between the load locks 106 and a plurality of substrate cassettes 105 which are mounted on the front-end environment 104.

The load locks 106 provide a first vacuum interface between the front-end environment 104 and a transfer chamber 110. Two load locks 106 are provided to increase throughput by alternatively communicating with the transfer chamber 110 and the front-end environment 104. Thus, while one load lock 106 communicates with the transfer chamber 110, a second load lock 106 may communicate with the front-end environment 104. A robot 113 is centrally disposed in the transfer chamber 110 to transfer substrates from the load locks 106 to one of the various processing chambers 114 or holding chambers 116. The processing chambers 114 are adapted to perform any number of processes such as film deposition, annealing, etching, while the holding chambers 116 are adapted for processes such as orientation and cool down.

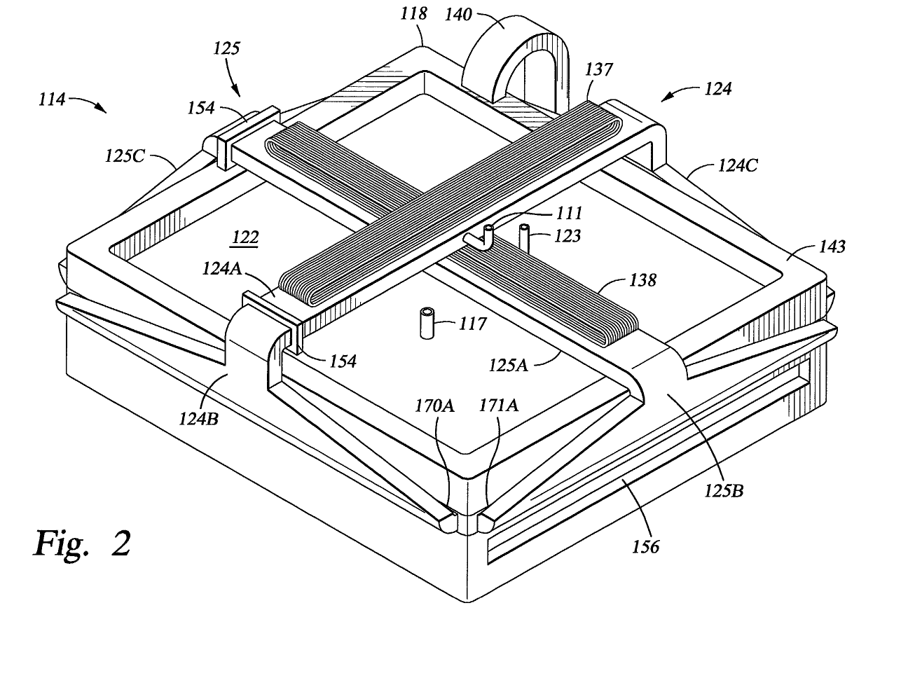

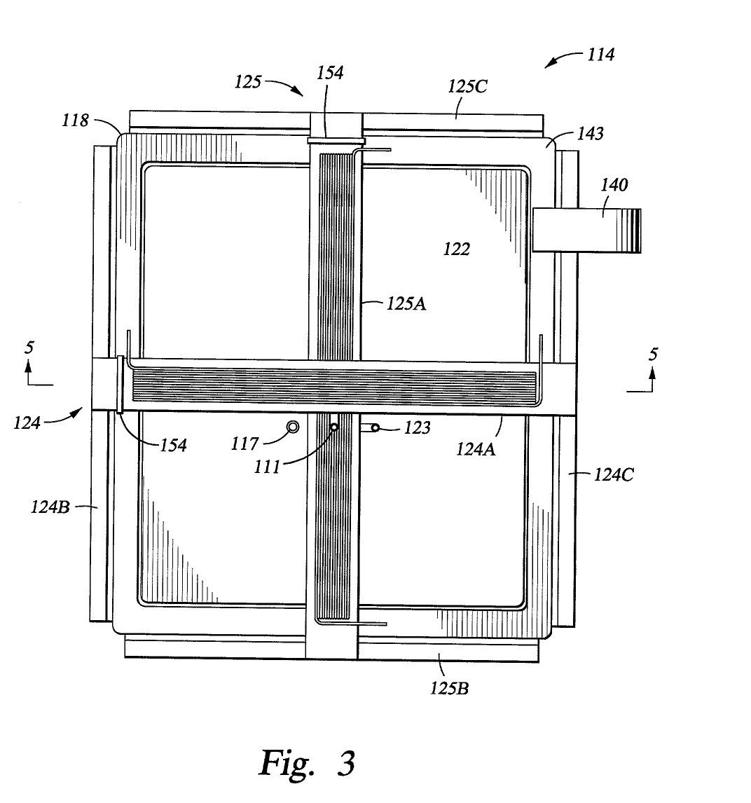

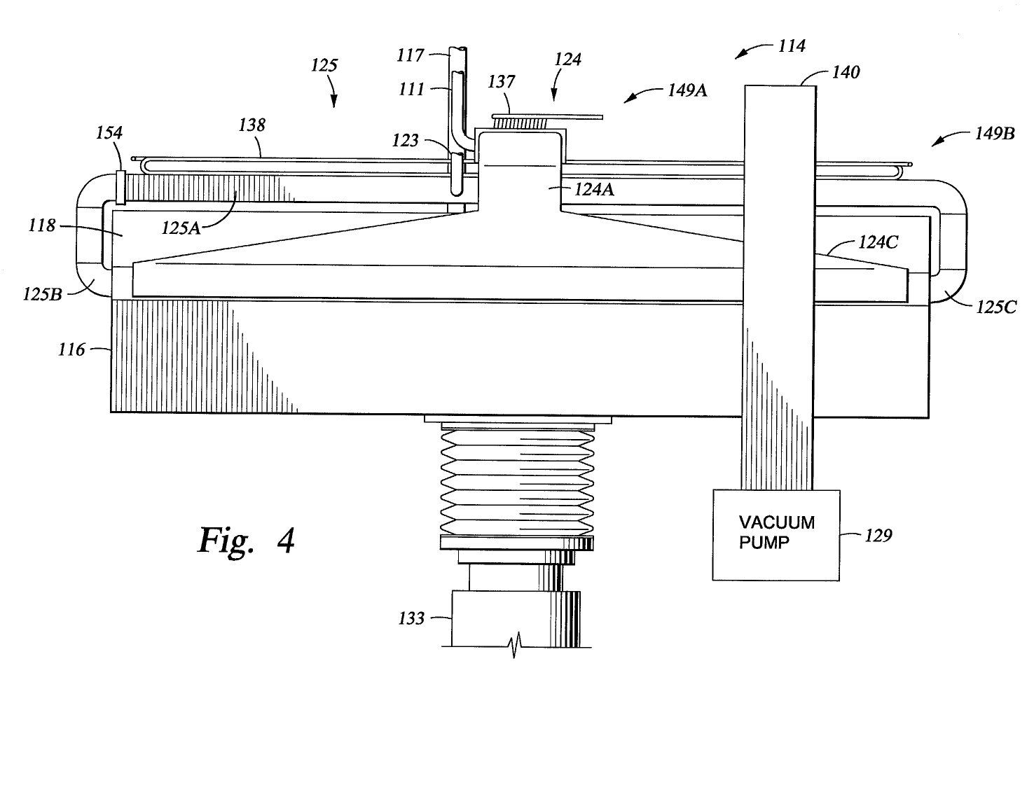

FIGS. 2, 3, and 4 are a top perspective view, top view, and side view, respectively, illustrating one embodiment of a processing chamber 114. In general, the processing chamber 114 has a polygonal shape in order to accommodate polygonal shaped substrates. The processing chamber 114 includes a body 116 having an opening 156 formed therein and shaped to accommodate the transfer of substrates into and out the processing chamber 114 by operation of the robot 113 (shown in FIG. 1). The opening 156 is selectively sealed by a sealing mechanism such as a gate valve or slit valve apparatus (not shown). Illustratively, only one opening 156 is shown. However, in other embodiments, two or more openings may be provided to allow access to the chamber through other chamber walls.

The processing chamber 114 further includes a first external hollow conduit 124 and a second external conduit 125 adapted to hold a process and/or cleaning gas therein. The gases are provided to the first and second hollow conduits 124, 125 via conduit gas inlets 111, 123, respectively. The conduits 124, 125 may be coupled to one or more external gas sources (not shown) containing gases such as argon, helium, hydrogen, oxygen, NF₃, and like. The conduits 124, 125 may be formed of a relatively thin conductor such as, aluminum, anodized aluminum, stainless steel, polymers, ceramics, and the like, sufficiently strong to withstand a vacuum therein.

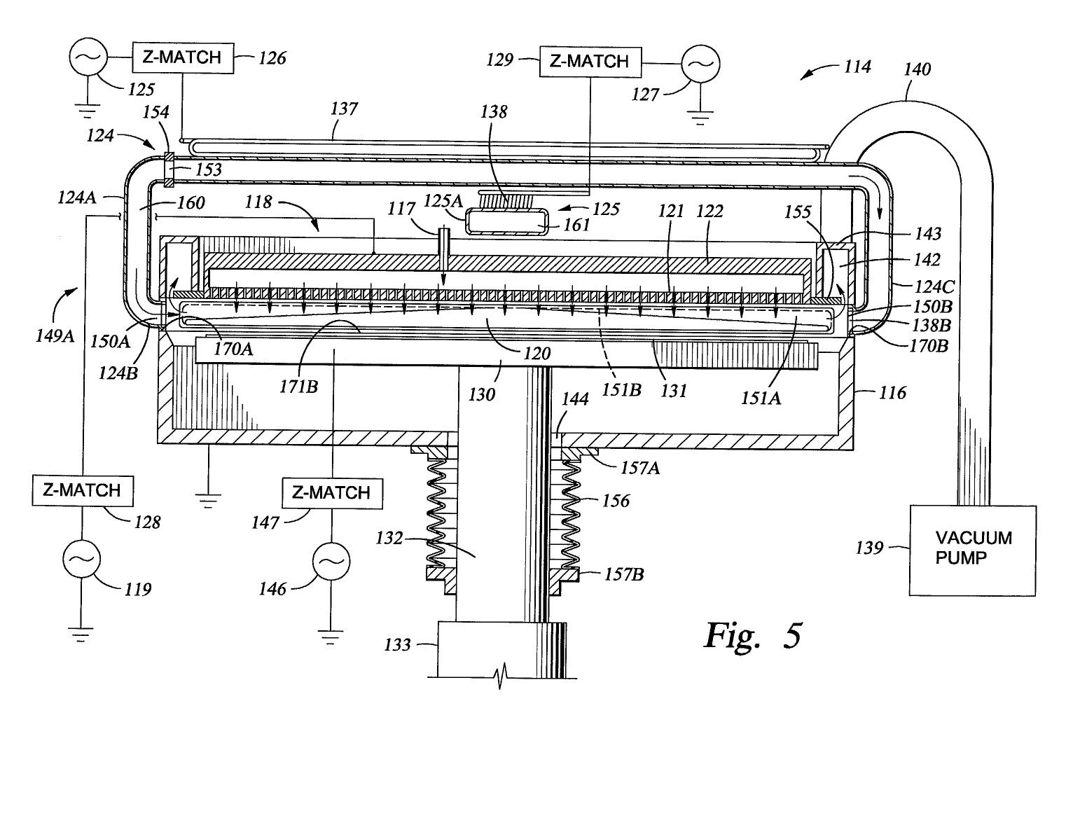

The first external hollow conduit 124 and second external hollow conduit 125 are disposed over and traverse a lid 118 of the processing chamber 114. The conduits 124, 125 are aligned generally orthogonal and are disposed above one another where the first conduit 124 is taller with respect to the lid 118 to allow the second conduit 125 to pass between the lid 118 and the first conduit 124. In one aspect, the conduits 124,125 are coupled to the body 116 using fasteners such as screws, bolts, and the like. The first and second conduits 124, 125 are coupled to an internal processing cavity of the processing chamber 114 discussed below with reference to FIG. 5. Although shown extending externally outward from the processing chamber 114 as separate components, the first and second conduits 124, 125 may be formed integrally to the lid 118.

First and second coil antennas 137, 138 are disposed proximate the conduits 124, 125, respectively and are adapted to couple RF energy into a process gas and/or cleaning gas within each respective conduit 124, 125. The RF energy excites the gas within each respective conduit 124, 125 to form plasma therein. The details and operation of the conduits 124, 125, the coil antennas 137, 138, and the processing chamber 114 will be discussed below with respect to FIG. 5. While the coil antennas 137, 138 may be used to couple RF energy into the conduits 124, 125, it is contemplated that the RF energy can also be coupled into the plasma within the conduits 124,125 using magnetic-flux-concentrating materials such as ferrites.

FIG. 5 is a cross-section of one embodiment of a processing chamber 114. FIGS. 1-4 may be referenced as needed with the discussion of FIG. 5. The processing chamber 114 includes a processing chamber body 116 and lid 118. The processing chamber body 116 and lid 118 define a cavity within the processing chamber 114 that includes a processing region 120 therein. A showerhead 122 disposed within the lid 118 defines the upper boundary of the processing region 120. The showerhead 122 comprises a gas inlet 117 and a plurality of dispersion holes 121 to allow delivery of one or more processing gases such as SiH₄, N₂O, NH₃, CH₄, TEOS, O₂, H₂, He, WF₆, NF₃, CF, C_{X}H_{Y}F_{Z}, CₓF_{y}, Trimethylsilane (TMS), therethrough into the processing region 120. In one aspect, the showerhead 122 acts as an anode coupled to a showerhead RF source 119 and matching network 128 to capacitvely couple RF energy to the processing region 120.

The processing chamber 114 also includes a movable substrate support member 130, also referred to as a susceptor, which can be raised or lowered in the processing chamber 114 by a lifting apparatus 133. A substrate support surface 131 of the substrate support member 130 defines the lower boundary of the processing region 120. The substrate support member 130 may be heated using resistive heaters, lamps, or other heating devices commonly used in the field of electronic device fabrication. A shaft 132 of the substrate support member 130 is moveably disposed through a floor of the body 116. In one aspect, an insulating o-ring 144 located in the floor and disposed around the shaft 132 can be used to electrically isolate the support member 130 while also providing a vacuum seal. In one aspect, a bellows 156 is coupled to an upper sealing ring 157A, disposed on the body 116, and is also coupled to lower sealing ring 157B disposed about the shaft 132 to provide an alternative vacuum seal. The substrate support 130 can then be coupled to a bias RF source 146 through a matching network 147. In operation, the bias RF source 146 is adjusted to vary the attraction of ion species toward the substrate.

In one aspect, the lid 118 includes an exhaust port 142 defined by a peripherally-mounted plenum structure 143 attached to and circumventing the perimeter of the lid 118 to allow process gases to be evacuated from the processing region 120. An insulating ring 155 electrically insulates the peripherally-mounted plenum structure 143 and lid 118 from the showerhead 122. A vacuum pump 139 is coupled to the processing chamber 114 to control the chamber pressure therein. The vacuum pump 139 may be any pump adapted to achieve and maintain a desired pressure. Illustrative pumps that may be used to advantage include turbopumps, cryo pumps, roughing pumps, and any combination thereof. Illustratively, the vacuum pump 139 communicates with the processing chamber 114 via an exhaust coupling 140. Specifically, the exhaust coupling 140 is connected at one end to the vacuum pump 139 and at another end to the plenum structure 143. While, a pumping position is shown where the gases are evacuated from the lid 118 forming a top-pumping configuration, it is contemplated that the vacuum pump could be coupled to the cavity from any location. For example, the vacuum pump 139 may be coupled to the bottom of the body 116 through a bottom exhaust port (not shown) forming a bottom-pumping configuration.

The first and second external hollow conduits 124,125 are disposed in alignment with a first opening pair 170A-B and second opening pair 171A-B formed within the body 116 to couple the conduits 124, 125 to the processing region 120 therein. The first w and second opening pairs 170A-B, 171A-B are generally axially aligned on opposite sides of the substrate support 130 and are positioned such that during processing they define a plasma current path extending across the processing region 120 and between the substrate support member 130 and showerhead 122. Internally, each conduit 124,125 shares the same evacuated atmosphere as exists elsewhere in the chamber cavity, including the processing region 120. During operation, the conduits 124,125 provide an external plasma current flow path from the processing region 120 and are coupled to the internal plasma current paths extending across the processing region via the first and second opening pairs 170A-B, 171A-B respectively. Thus, the conduits 124, 125 and the internal processing region 120 define two separate toroidal plasma current paths providing plasma current ingress into and egress from the processing chamber 114. Illustratively, the first conduit 124 and processing region 120 define a first toroidal plasma current path 160. The second conduit 125 and processing region 120 define a second toroidal plasma current path 161. Notwithstanding the use of the term “toroidal”, the trajectory of the closed path through each conduit 124, 125 and the processing region 120 may be circular, non-circular, square, rectangular, or any other shape either regular or irregular. Illustratively, the conduits 124, 125 and the toroidal plasma current paths 160-161 are generally rectangular in cross section but may be any other cross-sectional shape such as polygon, circular, elliptical and the like.

In one aspect, to ensure substantially equal plasma density, it is desirable to keep the plasma current paths 160-161 about the same length by adjusting the conduits 124,125 lengths. As the substrates and therefore the processing chamber 114 are often rectangular in shape, the narrower width of the processing chamber 114 relative to its length makes it desirable to position the first hollow conduit 124, which spans the width, above the second hollow conduit 125.

In another aspect, the first and second hollow conduits 124, 125 are generally narrower in width than the processing chamber 114 to facilitate inductive coupling of the excitation source energy to the plasma inside the conduit. Therefore, to mate with the first and second opening pairs 170A-B and 171A-B the first and second hollow conduits 124, 125 increase in width from a narrower upper member 124A, 125A to two wider lower ends 124B-C, 125B-C, that are adapted to mate with their respective opening pairs 170A-B, 171A-B. For example, the first hollow conduit 124 is registered with and coupled on a first lower end 124B-C, to the first inlet pair 170A-B. The second hollow conduit 125 is registered with and coupled on a second lower end 125B-C, to the second inlet pair 171A-B.

In one aspect, the first coil antenna 137 includes one or more turns about a longitudinal axis and is adapted to couple energy (illustratively RF energy) into the first conduit 124 from a first inductive RF source 125 through a matching network 126. The longitudinal axis of the first coil antenna 137 is disposed generally orthogonal to the longitudinal axis of the first conduit 124. The second coil antenna 138 includes one or more turns about a longitudinal axis and is adapted to couple energy (illustratively RF energy) into the second conduit 125 from a second inductive RF source 129 through an optional matching network 127 for better power utilization efficiency. The longitudinal axis of the second coil antenna 138 is disposed generally orthogonal to the longitudinal axis of the second conduit 125. While each coil antenna 137, 138 is wound in a generally flat elliptical shape that extends along a length of a respective conduit 124, 125, it is contemplated that the coil antennas 137, 138 can be of any shape or length adapted to couple RF energy into the respective first or second conduits 124, 125.

Each coil antenna 137,138 forms a primary transformer turn and the toroidal plasma current paths 160-161 define a secondary transformer turn, respectively. For example, the first coil antenna 137 forms a primary transformer turn and the plasma within the first toroidal path 160 forms a secondary transformer turn. In order to prevent electrically-conductive hollow conduits 124,125, from shorting the electric field generated by the magnetic field of the coil antennas (and thereby eliminating the possibility of generating a plasma within the conduits) an insulating gap 153 (only one gap is shown) extends across each hollow conduit 124,125. The gaps 153 are enclosed by a ring 154 of insulating material such as ceramic, glass, and the like adapted to provide electrical insulation while maintaining vacuum integrity of the conduits 124, 125. Alternatively, the hollow conduits 124,125 may be formed from a non-conductive material such as ceramic, glass, and the like, to eliminate any electric paths altogether without the need for the gaps 153.

In one aspect, the first and second coil antennas 137, 138 are wound so the currents within the coil antennas 137, 138 are about parallel to the plasma current flow within the respective first and second plasma current paths 160,161. As a result, the magnetic fields produced by the currents within each antenna coil 137, 138 are generally orthogonal to the direction of current flow through the first and second plasma current paths, respectively.

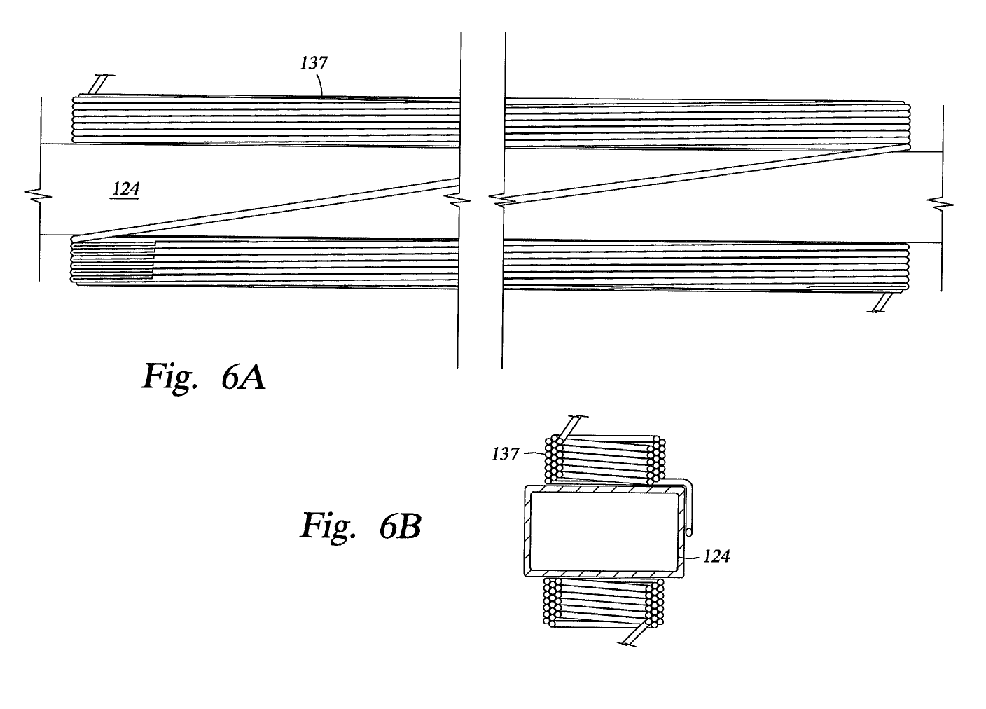

While the axial alignment of each coil 137, 138 relative to their respective conduits 124, 125 aligns the currents within the coil antennas 137, 138 to their respective plasma currents, the coil antennas 137, 138 may be placed in any position to achieve a desired plasma energy density. For example, the coil antennas 137, 138 may be wound such that the axis of the coil antennas 137, 138 are generally orthogonal to the longitudinal axis of their respective conduits 124, 125. Illustratively, FIGS. 6A and 6B depict one aspect whereby the first coil antenna 137 is wound such that the axis of the first coil antenna 137 is generally orthogonal to the longitudinal axis of its respective conduit 124. In another aspect, a portion of each antenna coil 137, 138 is wound on opposing sides of their respective conduits 124, 125 to enhance the energy coupling. For example, FIG. 6B illustrates the first coil antenna 137 wound on opposing sides of its conduit 124.

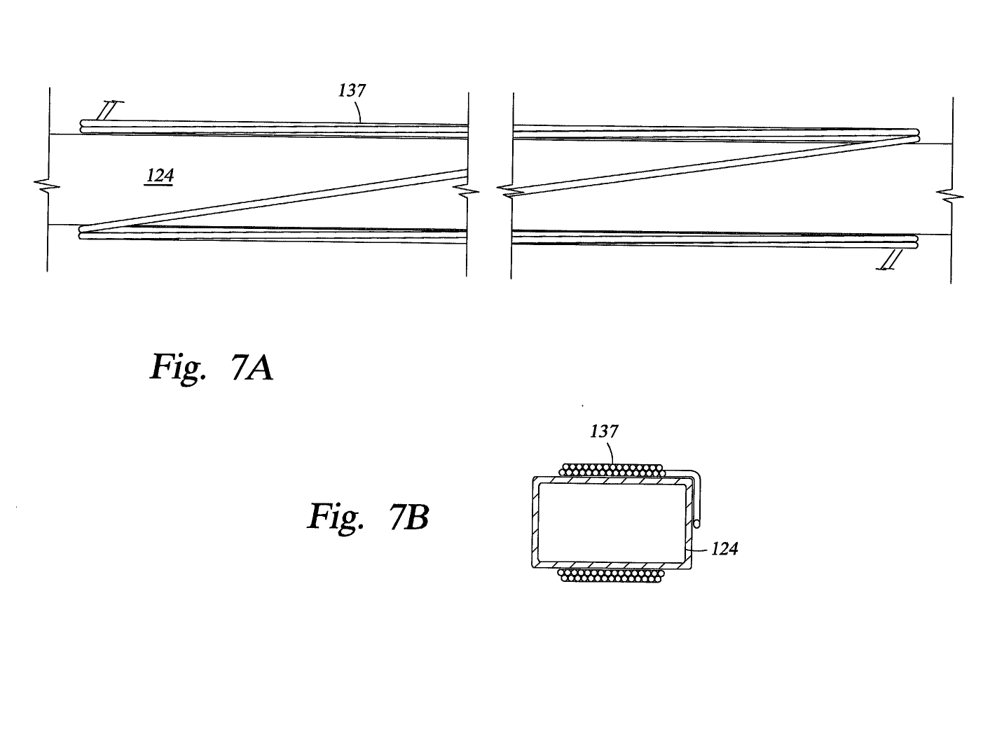

The coil antennas 137, 138, may also be wound in a helical flat winding, such that the windings are in closer proximity to the conduits 124, 125, thereby increasing the RF energy coupled into the plasma. For example, FIGS. 7A and 7B illustrate another configuration whereby the first coil antenna 137 is wound in a flat helical shape and whereby the longitudinal axis of the first coil antenna 137, 138, is aligned generally orthogonal to the longitudinal axis of their respective conduits 124, 125. The energy coupling into the plasma may also be increased by positioning the conduit between the windings so that a portion of the coil antenna 137, 138 are on opposing sides of the conduit 124, 125. For example, FIG. 7B illustrates the first coil antenna 137 is wound as a flat helical shape on opposing sides of the first conduit 124.

Referring back to FIG. 5, in one aspect, to provide a uniform coverage of the substrate surface, the toroidal plasma current paths 160,161 are aligned generally orthogonal so that the plasma from the first plasma current path 160 crosses processing region 120 generally orthogonal to the second plasma current path 161. The toroidal plasma current paths 160-161 are generally constrained within their respective conduits 124, 125, however, it is contemplated that the plasma formed in the shared volume above the substrate within the processing region 120 will allow “leakage” of currents between the plasma current paths 160, 161. To some extent this plasma leakage will aid in achieving a uniform plasma density in the shared volume above the substrate, however, it must be controlled to the extent necessary to affect uniform deposition and etching. In one aspect, to control the amount of plasma leakage between the first path 160 to the second path 161, a first plasma shaping apparatus pair 150A-B is disposed within the first opening pair 170A-B. Each member of the first plasma shaping apparatus pair 150A-B are aligned to generally face the other member across the processing region 120. In order to control the amount of plasma leakage from the second path 161 to the first path 160, a second plasma shaping apparatus pair 151A-B is disposed within the second opening pair 171A-B. Each member of the second plasma shaping apparatus pair 150A-B are aligned to generally face the other member across the processing region 120. The function of the plasma shaping apparatuses 150A-B, 151A-B is also to ensure that the natural tendency of the plasma in each toroidal plasma current loop 160,161 to take the shortest possible (minimum resistance) path across the shared volume does not result in the plasma being confined to narrow “bands” across mutually-orthogonal median lines of the volume. For example, if the plasma current density was greater along the middle of the substrate, the deposition or etch process would be exaggerated across the substrate middle affecting the process uniformity.

The first conduit 124, the first opening pair 170A-B, and the first plasma shaping apparatus pair 150A-B define a first external structure 149A representing a portion of the first toroidal plasma current path 160. The second conduit 125, the second opening pair 171A-B, and the second plasma shaping apparatus pair 151A-B define a second external structure 149B representing a portion of the second toroidal plasma current path 161. While the first and second plasma shaping apparatus pair 150A-B, 151A-B, are disposed within the first and second opening pair 170A-B, 171A-B, respectively, it is contemplated that the first and second plasma shaping apparatus pair 150A-B, 151A-B may be positioned in any location along the respective paths 160, 161. For example, the first and second plasma shaping apparatus pair 150A-B, 151A-B, may be disposed to the first and second lower ends 124B-C, 125B-C, of the conduits, 124, 125, or may be a coupling member adapted to couple the lower ends 124B-C, 125B-C, to the body 116 adjacent the opening pairs 170A-B, 171A-B.

Each member of the plasma shaping apparatus pairs 150A-B, 151A-B has an opening, the shape of which in turn determines the distribution of the plasma within the volumes on either side of the apparatus pairs 150A-B, 151A-B. The current produced by the induced electric field, which creates and sustains the plasma in each toroidal plasma current path 160, 161, is constricted by the smaller portions of the opening to alter the plasma distribution within the processing region 120. In one aspect, the plasma shaping apparatus pairs 150A-B, 151A-B are formed from material about ⅛″ inch to about ¼″ inch thick to provide a plasma constriction momentarily increasing the plasma current density. In general, the plasma shaping apparatus pairs 150A-B, 151A-B are formed of metallic materials such as aluminum, stainless steel, anodized aluminum.

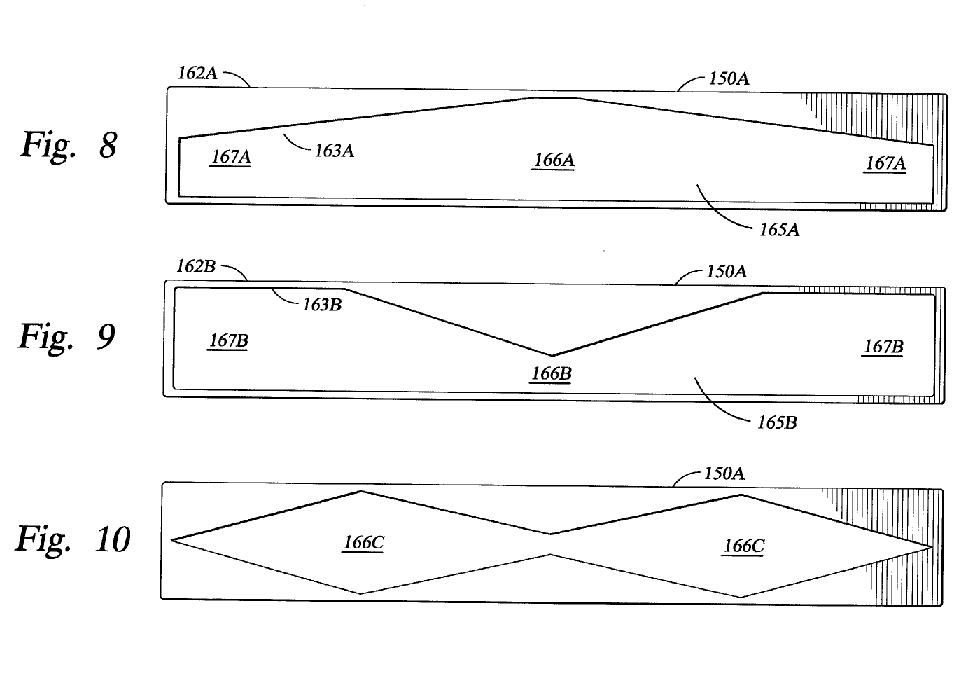

In one aspect, the plasma shaping apparatus pairs 150A-B, 151A-B are adapted to be changeable between and/or during a process to create different plasma current flow patterns across the processing region 120. For example, FIG. 8 illustrates one embodiment for one member 150A of the first plasma shaping apparatus pair 150A-B having a larger center cross sectional area 166A and two outer smaller regions 167A. The inner periphery 163A acts to define a desired plasma current distribution in the processing region 120 by creating a distributed impedance to the current flowing in the plasma. A higher current density at the center 166A of the opening may be used, for example, to increase the deposition along the central region of the substrate parallel to the current flow through the plasma shaping apparatus pair 150A-B.

FIG. 9 illustrates another embodiment of one member 150A of the first plasma shaping apparatus pair 150A-B where an inner periphery 163B defines a narrowed center portion 166B and two larger outer portions 167B that are generally opposite each other and on either side of the center portion 166B. As the plasma current flows through the opening, the constriction at the center portion 166B forces more of the plasma current through the wider portions of the opening 167B thereby decreasing plasma density along the middle of the plasma current flow within the processing region 120. During substrate processing, decreasing the plasma density along the middle of the plasma current flow decreases the deposition or etching rate along the middle of the substrate.

It is contemplated that the inner periphery 163A-B may be adapted to establish any opening to shape the plasma current flow into any desired density distribution. For example, FIG. 10 illustrates that outer portions 167A-B and the center portion 166A-B may define two or more openings 166C that constrict the plasma current on the edges and the middle of the processing region. In another example, with regard to cleaning, the plasma shaping apparatus pairs 150A-B and 151A-B may be removed entirely. Additionally, the plasma shaping apparatus pairs 150A-B and 151A-B may be adapted to have a narrower or larger opening to accommodate smaller, or larger, substrates within the same chamber, respectively, or to control the amount of overall ion density distribution within the processing region 120.

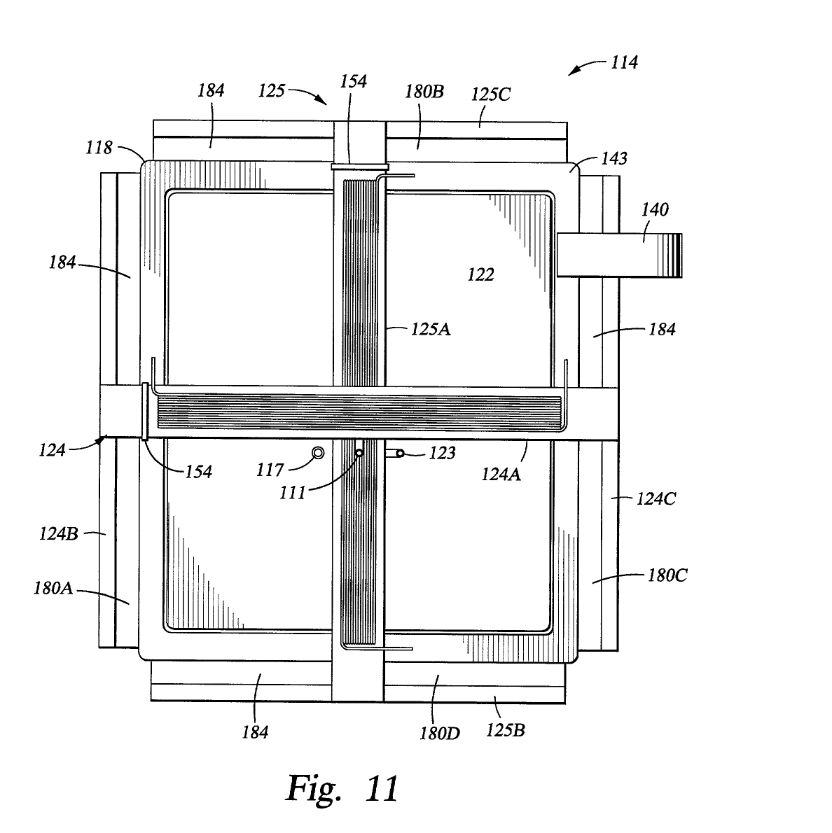

In one embodiment, the plasma current flow may be shaped magnetically. FIG. 11 is a top view of one the processing chamber 114 including four magnetic plasma shaping apparatuses 180A-D. In one aspect, each of the four magnetic plasma shaping apparatuses 180A-D is disposed above and below and across the length of one of the wider lower ends 124B-C, 125B-C adjacent the chamber 114. The four magnetic plasma shaping apparatuses 180A-D are adapted to provide a magnetic field within the hollow conduits 124, 125 at the lower ends 124B-C, 125B-C, respectively, to form a magnetic opening to shape the plasma current flow therein.

The magnetic plasma shaping apparatuses 180A-D include a plurality of magnetic elements 184 such as electromagnets, permanent magnets, and the like, disposed above and/or below the first and second lower ends 124B-C, 125B-C. The magnetic elements are adapted to provide a desired magnetic field profile which in turn defines a plasma current flow profile within the lower ends 124B-C, 125B-C to control the plasma current flow through each path 160-161 through the processing region 120. For example, by using a plurality of magnetic elements 184 having different magnetic field strengths and/or by varying the position of the magnetic elements 184 along the width and/or proximity to the plasma current therein of the lower ends 124B-C, 125B-C, a plurality of plasma current flow profiles may be formed. In one aspect, the magnetic elements 184 include one or more electromagnetic coils coupled to a DC power source, or sources (not shown), to set the level of the electromagnetic fields therein. It is contemplated that the strength of the current within each electromagnetic coil may be adjusted to alter the magnetic field profile to adjust and/or define a desired plasma current flow profile from process to process, or during a particular process.

In one aspect, the magnetic poles of the magnetic elements 184 are set parallel to define a common magnetic field polarization with respect to the plasma, thereby minimizing plasma leakage to the walls of the hollow conduits 124, 125. For example, the south pole of each magnetic element 184 is set orthogonal to and facing the plasma.

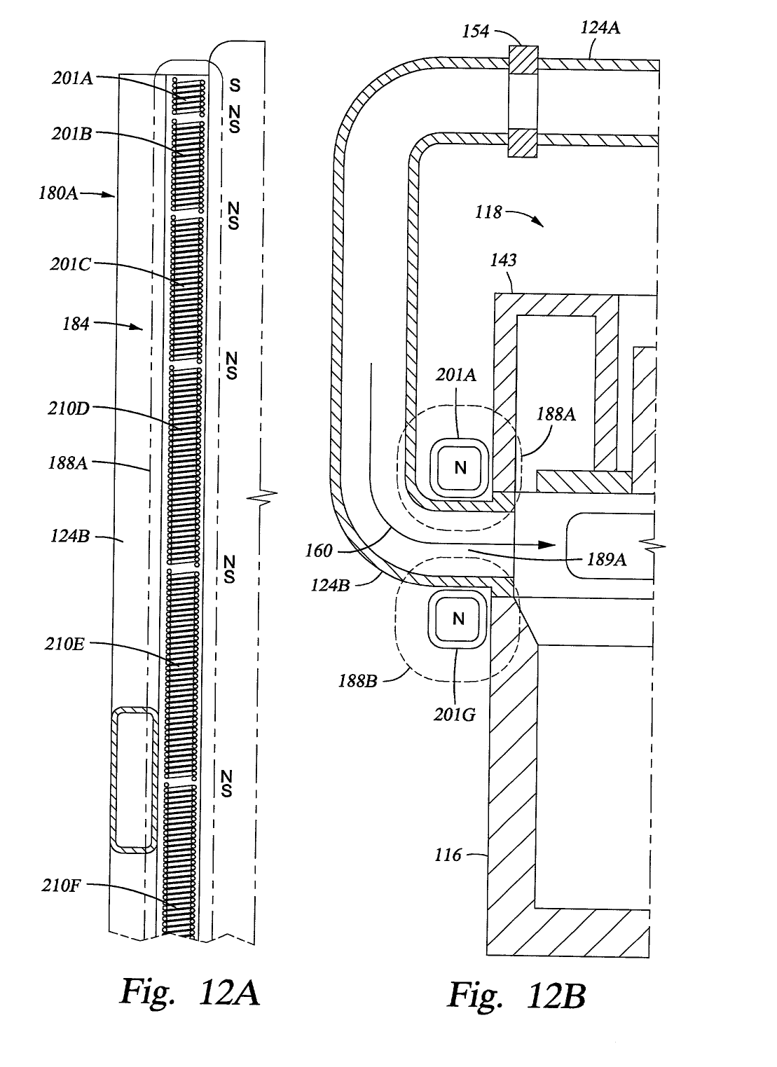

It is contemplated that the magnetic poles may be set to any desired position or configuration to attain a desired magnetic field profile. For example, FIGS. 12A-B through 21A-B are cut away top and side views illustrating various configurations of a first magnetic plasma shaping apparatuses 180A using magnetic elements 184 including electromagnetic coils and/or permanent magnets. While only one magnetic plasma shaping apparatus 180A is shown, the FIGS. 12A-B through 21A-B illustrate only a few of the plurality of configurations for each of the four magnetic plasma shaping apparatuses 180A-D.

FIGS. 12A-B illustrate one embodiment of the first magnetic plasma shaping apparatus 180A. A plurality of electromagnetic coils 201A-G varying in dimension are disposed above, below, and along the width of the first lower end 124B and have their longitudinal axis aligned generally orthogonal to the first plasma current path 160. In one aspect, a plurality of first electromagnetic coils 201A-F are disposed above the first lower end 124B. The first electromagnetic coils 201A-F have their magnetic poles aligned with, adjacent, and juxtaposed to a plurality of second electromagnetic coils 201G disposed below the first lower end 124B. To form an opposing magnetic field, the magnetic poles of the first electromagnetic coils 201A-F are generally aligned with and the same as poles of the second electromagnetic coils 201G. Further, the magnetic north and south poles of adjacent discrete coils are adjacent. For example, the magnetic north pole of electromagnetic coil 201A is facing and adjacent the magnetic south pole of the electromagnetic coil 201B. Illustratively, the first electromagnetic coils 201A-F provide an upper magnetic field 188A adjacent the toroidal path 160. The second electromagnetic coils 201G provide a lower magnetic field 188B adjacent the toroidal path 160 and below the upper magnetic field 188A. The upper and lower magnetic fields 188A, 188B define a magnetic opening 189A disposed adjacent the lower end 124B. The magnetic opening 189A is disposed within and about orthogonal to the plasma current path 160.

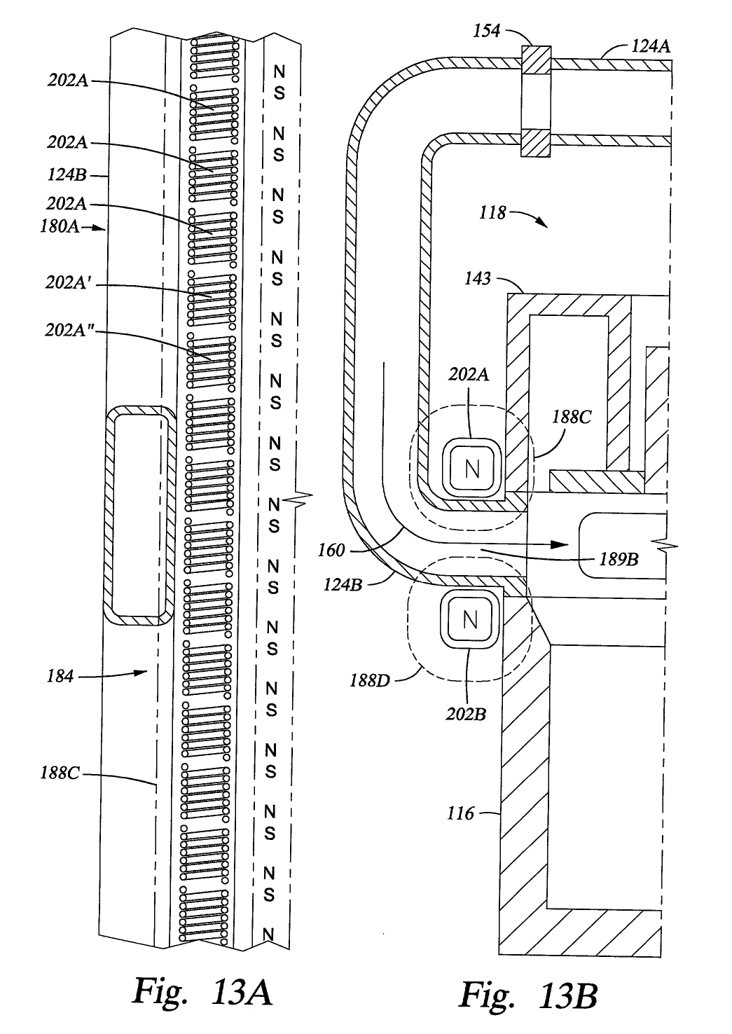

FIGS. 13A-B illustrate another configuration of the first magnetic plasma shaping apparatus 180A. A plurality of first electromagnetic coils 202A are disposed above and below and along the width of the first lower end 124B. The first electromagnetic coils 202A have their longitudinal axis aligned generally orthogonal to the first plasma current path 160. In one aspect, the plurality of first electromagnetic coils 202A are disposed above the first lower end 124B. The first electromagnetic coils 202A have their magnetic poles aligned, are adjacent to, and juxtaposed the plurality of second electromagnetic coils 202G disposed below the first lower end 124B. To form an opposing magnetic field, the magnetic poles of the first electromagnetic coils 202A are aligned with and the same type as the magnetic poles of the second electromagnetic coils 202G (e.g., south poles are aligned). Further, the magnetic north and south poles of adjacent discrete coils are opposite. For example, the magnetic north pole of a first discrete electromagnetic coil 202A′ is facing and adjacent the magnetic south pole of an adjacent second electromagnetic coil 202A″. Illustratively, the first electromagnetic coils 202A provide an upper magnetic field 188C disposed adjacent the toroidal path 160. The second electromagnetic coils 202H provide a lower magnetic field 188D disposed adjacent the toroidal path 160 and below the upper magnetic field 188C. The upper and lower magnetic fields 188C, 188D define a magnetic opening 189B disposed adjacent the lower end 124B and generally disposed within and orthogonal to the plasma current path 160.

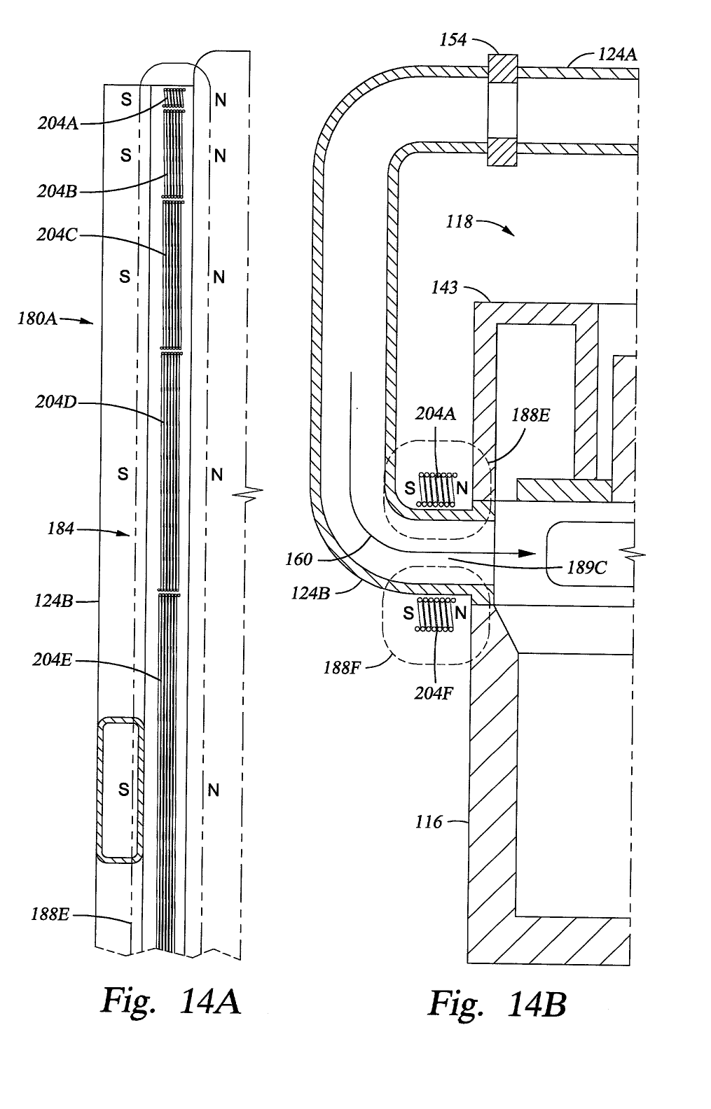

FIGS. 14A-B illustrate another configuration of the first magnetic plasma shaping apparatus 180A. A plurality of first and second electromagnetic coils 204A-F of varying length are disposed along the width and above and below the first lower end 124B and have their longitudinal axis aligned generally aligned with the first plasma current path 160. In one aspect, the plurality of first electromagnetic coils 204A-E disposed above the first lower end 124B. The first electromagnetic coils 204A-E have their magnetic poles aligned, adjacent to and juxtaposed the plurality of second electromagnetic coils 204F disposed below the first lower end 124B. To form an opposing magnetic field, the magnetic poles of the first electromagnetic coils 204A-E are aligned with the magnetic poles of the second electromagnetic coils 204F. Further, the magnetic north and south poles of adjacent discrete coils are aligned. For example, the magnetic north pole of a first discrete electromagnetic coil 204A is aligned with the magnetic north pole of an adjacent second electromagnetic coil 204B. Illustratively, the first electromagnetic coils 204A-E provide an upper magnetic field 188E disposed adjacent the toroidal path 160. The second electromagnetic coils 202F provide a lower magnetic field 188F disposed adjacent the toroidal path 160 and below the upper magnetic field 188E. The upper and lower magnetic fields 188E, 188F define a magnetic opening 189C disposed adjacent the lower end 124B and generally orthogonal to the plasma current path 160.

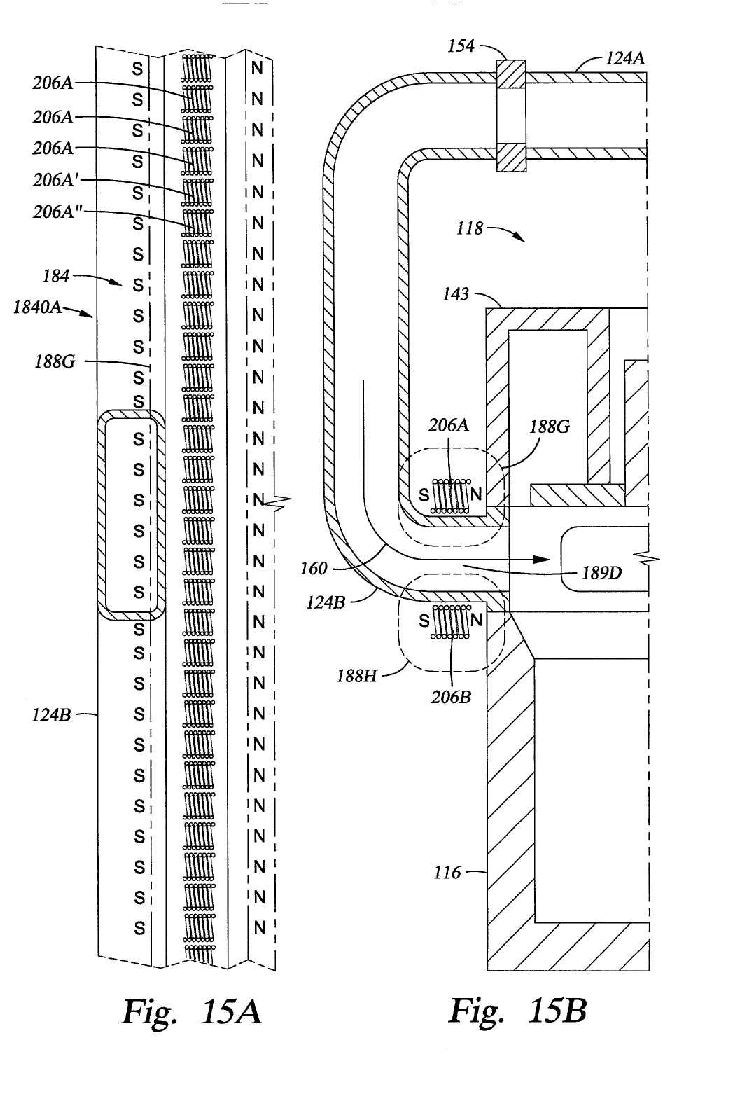

FIGS. 15A-B illustrate another configuration of the first magnetic plasma shaping apparatus 180A. A plurality of first and second electromagnetic coils 206A-B are disposed above, below, and along the width of the first lower end 124B and have their longitudinal axis aligned generally with the first plasma current path 160. In one aspect, the plurality of first electromagnetic coils 206A are disposed above the first lower end 124B. The first electromagnetic coils 206A have their magnetic poles aligned with the plurality of second electromagnetic coils 206B disposed below the first lower end 124B. To form an opposing magnetic field, the magnetic poles of the first electromagnetic coils 206A are aligned with the magnetic poles of the second electromagnetic coils 206B (e.g., south pole of the first coil opposite the south pole of the second coil). Further, the magnetic north and south poles of adjacent discrete coils are aligned. For example, the magnetic north pole of a first discrete electromagnetic coil 206A′ is aligned with the magnetic north pole of an adjacent second electromagnetic coil 206A″. Illustratively, the first electromagnetic coils 206A provide an upper magnetic field 188G disposed adjacent the toroidal path 160. The second electromagnetic coils 206H provide a lower magnetic field 188H disposed adjacent the toroidal path 160 and below the upper magnetic field 188G. The upper and lower magnetic fields 188G, 188H define a magnetic opening 189D disposed adjacent the lower end 124B and generally orthogonal to the plasma current path 160.

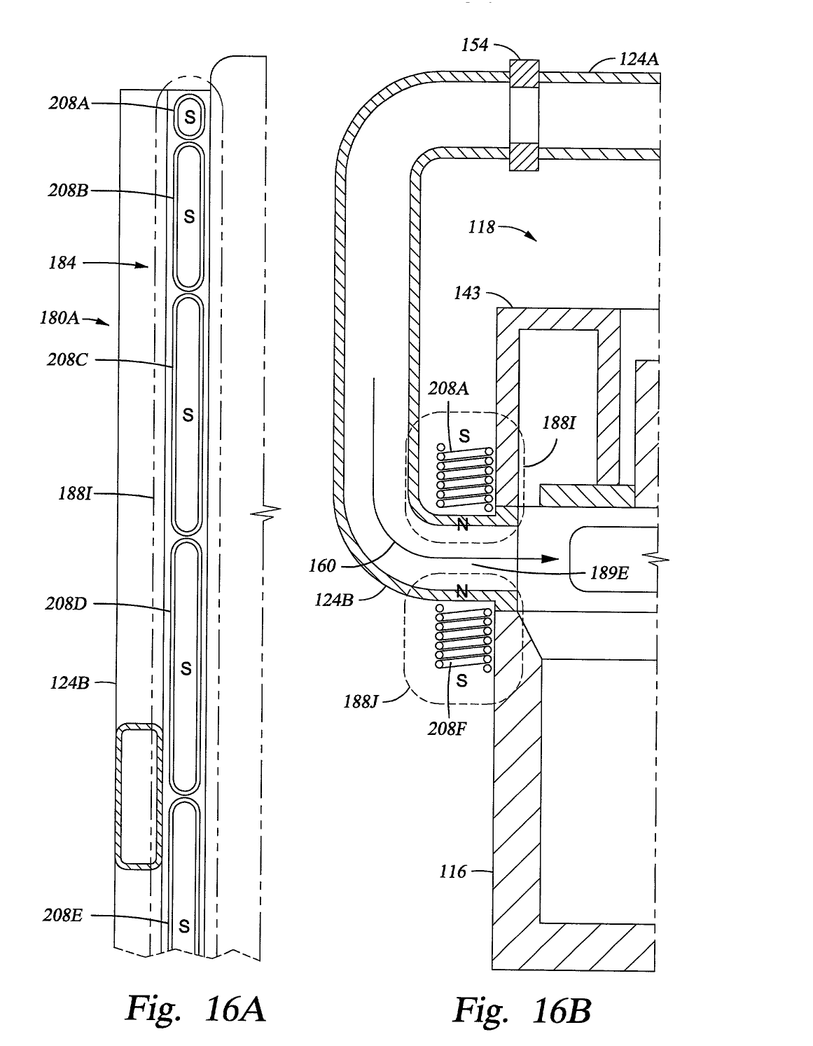

FIGS. 16A-B illustrate another configuration of the first magnetic plasma shaping apparatus 180A. A plurality of first and second electromagnetic coils 208A-F are disposed above, below, and along the width of the first lower end 124B and have their longitudinal axis aligned generally orthogonal to the first plasma current path 160. In one aspect, the plurality of first electromagnetic coils 208A-E are disposed above the first lower end 124B and have their magnetic poles aligned adjacent to and juxtaposed the plurality of second electromagnetic coils 208F disposed below the first lower end 124B. To form an opposing magnetic field, the magnetic poles of the first electromagnetic coils 208A-E are aligned with the magnetic poles of the second electromagnetic coils 208F. Further, the magnetic north and south poles of adjacent discrete coils are aligned. For example, the magnetic north pole of a first discrete electromagnetic coil 208A is aligned with the magnetic north pole of an adjacent second electromagnetic coil 208B. Illustratively, the upper electromagnetic coils 208A-E provide an upper magnetic field 1881 disposed adjacent the toroidal path 160. The second electromagnetic coils 208F provide a lower magnetic field 188J disposed adjacent the toroidal path 160 and below the upper magnetic field 1881. The upper and lower magnetic fields 188I, 188J define a magnetic opening 189E disposed adjacent the lower end 124B and generally orthogonal to the plasma current path 160.

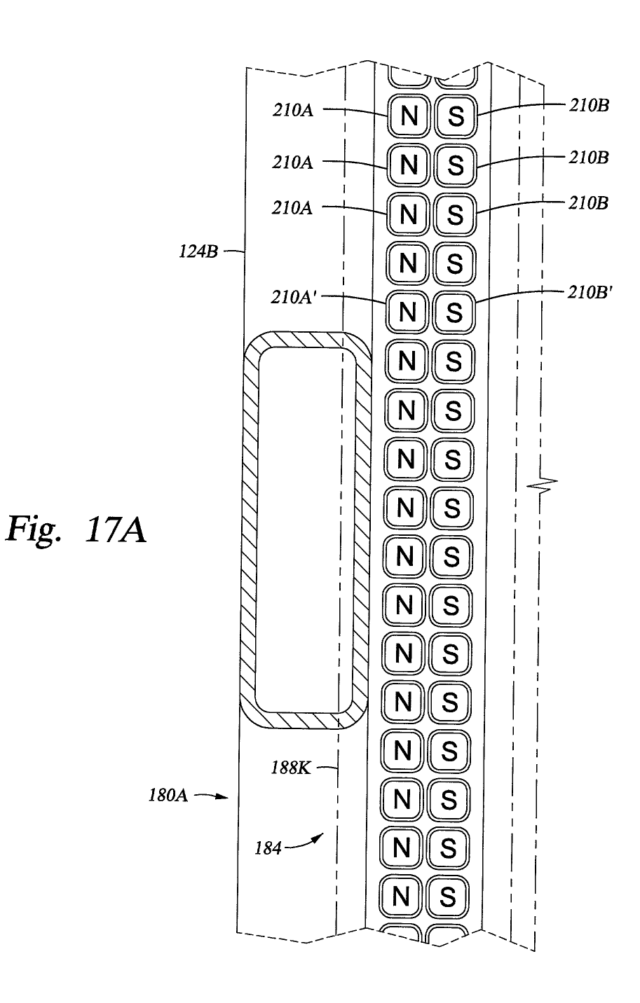

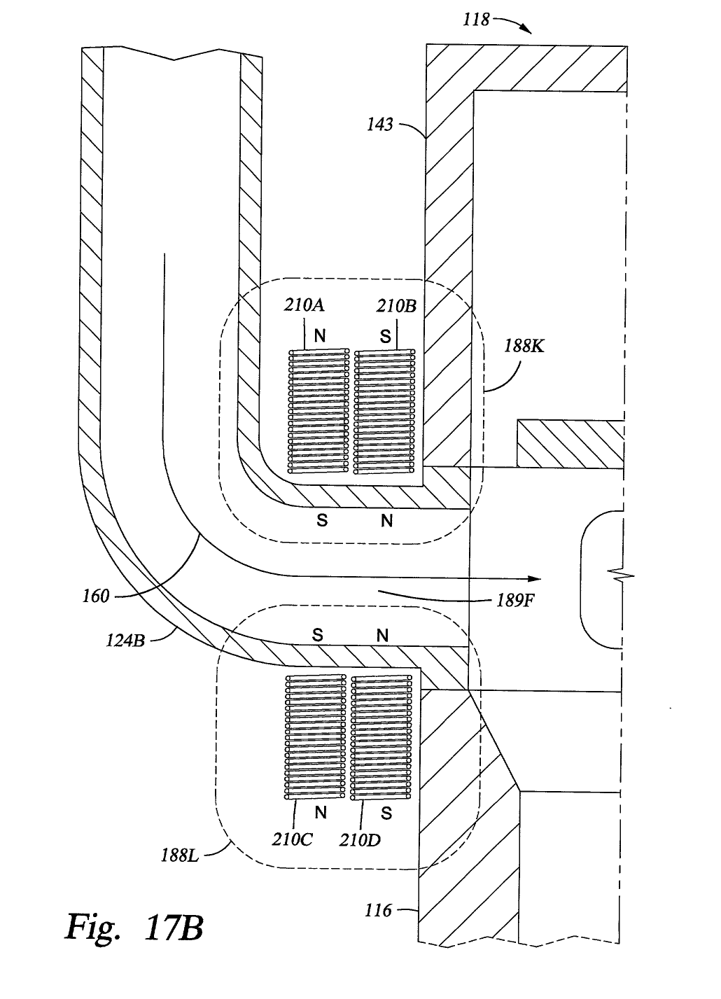

FIGS. 17A-B illustrates another configuration of the first magnetic plasma shaping apparatus 180A. A plurality of first and second electromagnetic coils 210A-D are disposed along the width of the first lower end 124B and have their longitudinal axis aligned generally orthogonal to the first plasma current path 160. In one aspect, the plurality of first electromagnetic coils 210A-B disposed above the first lower end 124B have their magnetic poles aligned and are adjacent to and juxtaposed the plurality of second electromagnetic coils 210C-D disposed below the first lower end 124B. To form an opposing magnetic field, the magnetic poles of the first electromagnetic coils 210A-B are aligned with the magnetic poles of the adjacent second electromagnetic coils 210C-D. Further, the magnetic north and south poles of the adjacent discrete coils 210A-B and 210C-D are opposed. For example, the magnetic north pole of a first discrete electromagnetic coil 210A′ is aligned with the magnetic south pole of an adjacent second electromagnetic coil 210B′. Still further, the magnetic north and south poles of adjacent first and second electromagnetic coils 210A-D are opposing. For example, the magnetic south pole of the first discrete electromagnetic coil 210A is opposite the south pole of an adjacent second electromagnetic coil 210C. Illustratively, the plurality of first electromagnetic coils 210A provides an upper magnetic field 188K disposed adjacent the toroidal path 160. The plurality of second electromagnetic coils 210C-D provides a lower magnetic field 188L disposed adjacent the toroidal path 160 and below the upper magnetic field 188K. The upper and lower magnetic fields 188K, 188L define a magnetic opening 189F disposed adjacent the lower end 124B and generally orthogonal to the plasma current path 160.

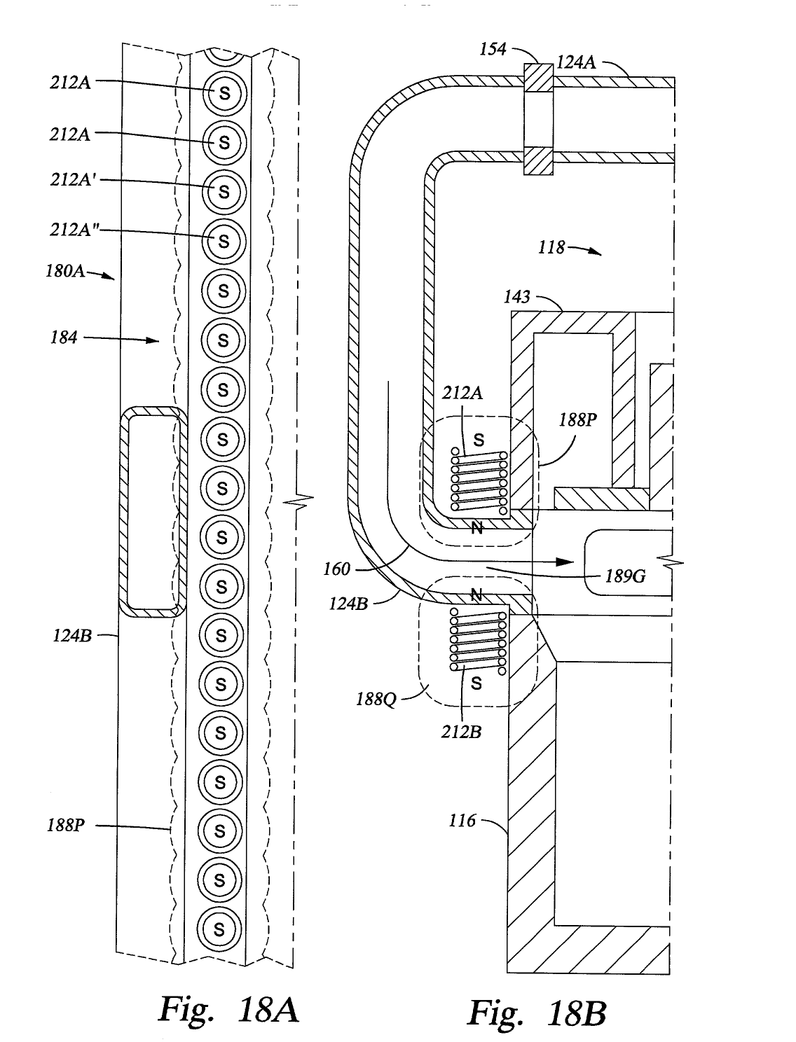

FIGS. 18A-B illustrate another configuration of the first magnetic plasma shaping apparatus 180A. In one aspect, a plurality of first and second electromagnetic coils 212A-B are disposed above, below, and along the width of the first lower end 124B and have their longitudinal axis aligned generally orthogonal to the first plasma current path 160. To form an opposing magnetic field, the plurality of first electromagnetic coils 212A disposed above the first lower end 124B have their magnetic poles aligned adjacent to and juxtaposed the plurality of second electromagnetic coils 212B disposed below the first lower end 124B. For example, the north pole of the first electromagnetic coils 212A are aligned with the north poles of the second first electromagnetic coils 212B. Further, the magnetic north and south poles of adjacent discrete coils are aligned. For example, the magnetic south pole of a first discrete electromagnetic coil 212A′ is aligned with the magnetic south pole of an adjacent second electromagnetic coil 212A″. Illustratively, the first electromagnetic coils 212A provide an upper magnetic field 188P disposed adjacent the toroidal path 160. The second electromagnetic coils 212B provide a lower magnetic field 188Q disposed adjacent the toroidal path 160 and below the upper magnetic field 188P. The upper and lower magnetic fields 188P, 188Q define a magnetic opening 189G disposed adjacent the lower end 124B and generally orthogonal to the plasma current path 160.

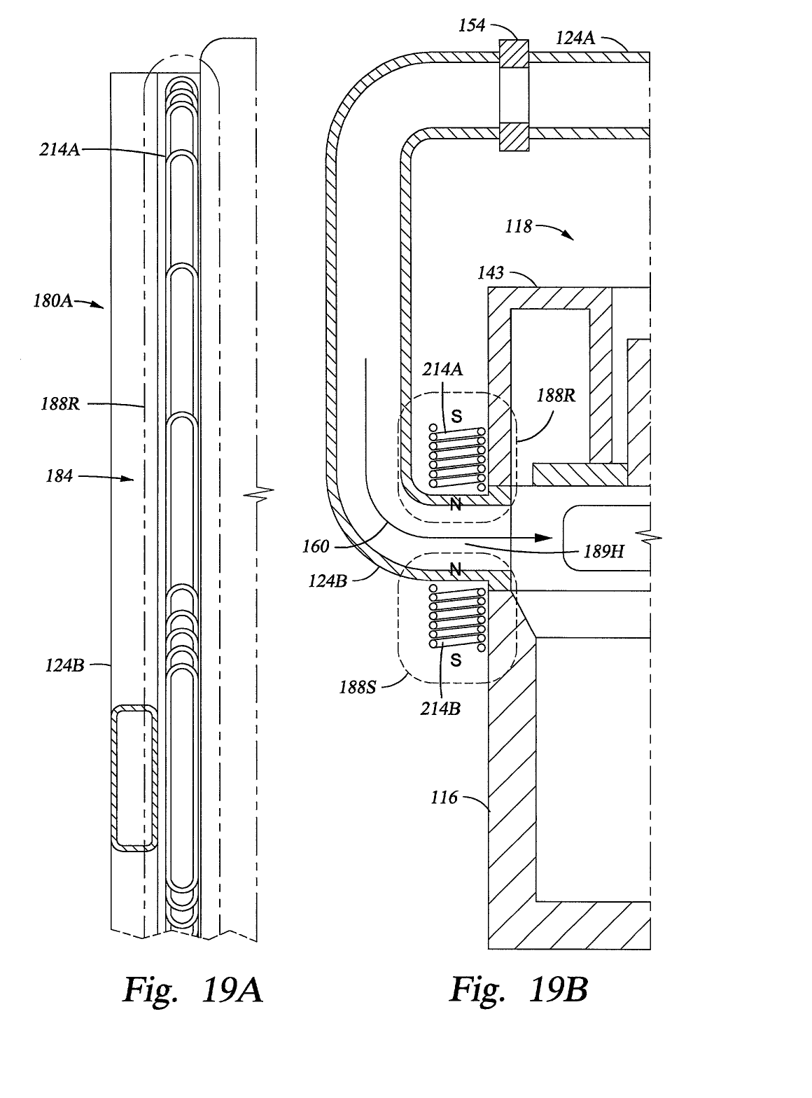

FIGS. 19A-B illustrate another configuration of the first magnetic plasma shaping apparatus 180A. A first and second electromagnetic coil 214A-B having windings of varying lengths are disposed along the width of the first lower end 124B and have their longitudinal axis aligned generally orthogonal to the first plasma current path 160. In one aspect, to form an opposing magnetic field the first electromagnetic coil 214A is disposed above the first lower end 124B, has its magnetic pole aligned with the second electromagnetic coil 214B disposed below the first lower end 124B. The magnetic pole of the first electromagnetic coil 214A is generally aligned with the magnetic pole of the second electromagnetic coil 214B. Further, the magnetic poles of the first and second electromagnetic coils 214A-B that face each other are the same. For example, the magnetic north pole of the first electromagnetic coil 214A is opposite the magnetic north pole of the second electromagnetic coil 214B. Illustratively, the first electromagnetic coils 214A provide an upper magnetic field 188R disposed adjacent the toroidal path 160. The second electromagnetic coils 214B provide a lower magnetic field 188S disposed adjacent the toroidal path 160 and below the upper magnetic field 188R. The upper and lower magnetic fields 188R, 188S define a magnetic opening 189H disposed adjacent the lower end 124B and generally orthogonal to the plasma current path 160. In another aspect, the first and second coils may include a plurality of coils of varying length that are disposed upon each other and having their longitudinal axis aligned. For example, the first electromagnetic coil 214A may comprise six windings of varying length, each of which is a separate coil with the longitudinal axis of each of the six coils aligned.

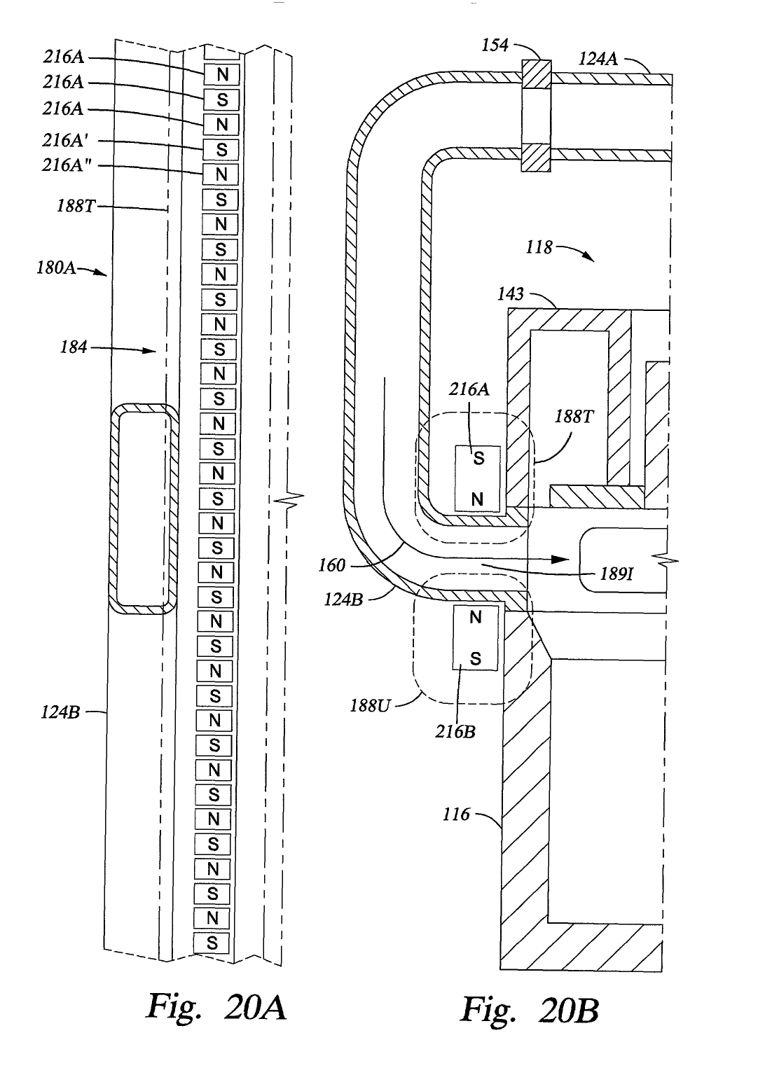

FIGS. 20A-B illustrate another configuration of the first magnetic plasma shaping apparatus 180A. A plurality of upper and lower permanent magnets 216A-B are disposed above, below, and along the width of the first lower end 124B and have their longitudinal axis aligned generally orthogonal to the first plasma current path 160. In one aspect, the plurality of first permanent magnets 216A disposed above the first lower end 124B have their magnetic poles aligned and are adjacent to and juxtaposed the plurality of second permanent magnets 216B disposed below the first lower end 124B. To form an opposing magnetic field, the magnetic poles of the first permanent magnets 216A are aligned with the same magnetic poles of the second permanent magnets 216B. For example, the north poles of the first permanent magnets 216A are opposite the north poles of the second permanent magnets 216B. Further, the magnetic north and south poles of adjacent discrete permanent magnets are aligned but opposite. For example, the magnetic north pole of a first discrete permanent magnet 216A′ is aligned with the magnetic south pole of an adjacent second discrete permanent magnet 216A″. Illustratively, the plurality of first permanent magnets 216A provide an upper magnetic field 188T disposed adjacent the toroidal path 160. The plurality of second permanent magnets 214B provide a lower magnetic field 188U disposed adjacent the toroidal path 160 and adjacent the upper magnetic field 188T. The upper and lower magnetic fields 188T, 188U define a magnetic opening 1891 disposed adjacent the lower end 124B and generally orthogonal to the plasma current path 160.

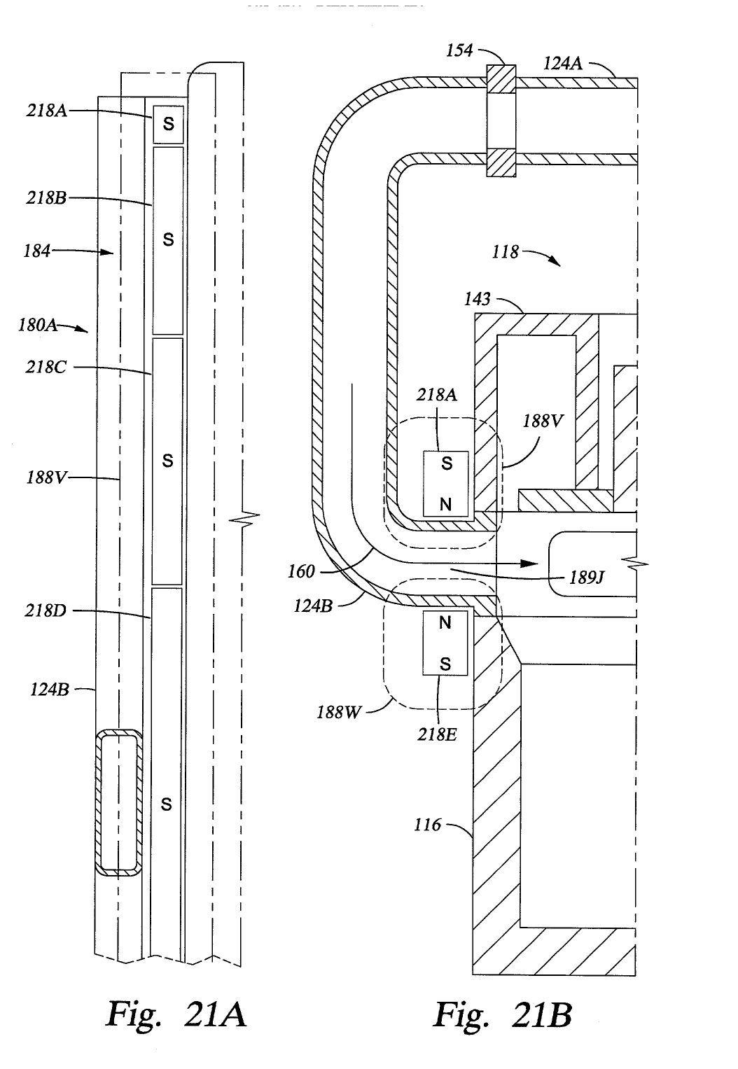

FIGS. 21A-B illustrates another configuration of the first magnetic plasma shaping apparatus 180A. A plurality of first and second permanent magnets 218A-E of varying dimensions are disposed above, below, and along the width of the first lower end 124B and have their longitudinal axis aligned generally orthogonal to the first plasma current path 160. In one aspect, the plurality of first permanent magnets 218A-D disposed above the first lower end 124B have their magnetic poles aligned and are adjacent to and juxtaposed the plurality of second permanent magnets 218E disposed below the first lower end 124B. To form an opposing magnetic field, the magnetic poles of the first permanent magnets 218A-D are aligned with the same magnetic poles of the second permanent magnets 218E. For example, the north poles of the first permanent magnets 218A-D are opposite the north poles of the second permanent magnets 218E. Further, the magnetic north and south poles of adjacent discrete permanent magnets are aligned. For example, the magnetic north pole of a first discrete permanent magnet 218A is aligned with the magnetic north pole of an adjacent second discrete permanent magnet 218B. Illustratively, the plurality of first permanent magnets 218A-D provide an upper magnetic field 188V disposed adjacent the toroidal path 1-60. The plurality of second permanent magnets 218B provide a lower magnetic field 188W disposed adjacent the toroidal path 160 and adjacent the upper magnetic field 188V. The upper and lower magnetic fields 188V, 188W define a magnetic opening 189J disposed adjacent the lower end 124B and generally orthogonal to the plasma current path 160.

FIGS. 12A-B, through FIGS. 21A-B, illustrate only a few of the plurality of magnetic element 184 configurations. For example, in one aspect the magnetic elements 184 may be a combination of both electromagnets and permanent magnets. In another aspect, the electromagnetic elements 184 may be formed into a single interchangeable apparatus. In still another aspect, the distance the electromagnetic elements 184 relative to the plasma may be adjusted to increase or decrease the magnetic field strength. In another aspect, the plurality of permanent magnets may be formed into a single magnet. While in one aspect the magnetic plasma shaping apparatuses 180A-D may be used alone, it is contemplated that one or more of the magnetic plasma shaping apparatuses 180A-D may be used in combination with the plasma shaping pairs 150A-B, 151A-B to define a desired plasma current profile.

Operation

During substrate processing, a gas is introduced into the hollow conduits 124,125 via gas inlets 111 and 123 respectively. The respective excitation sources 125 and 126 generate a current within the coil antennas 137,138, to couple electromagnetic energy into the gas within each conduit 124, 125, thereby striking plasma therein. A separate trigger circuit (not shown in illustrations) may also be used to facilitate plasma ignition. Plasma current and plasma then circulate though each toroidal plasma current path 160-161 through the respective plasma shaping apparatus pairs 150A-B and 151A-B and/or magnetic plasma shaping apparatuses 180A-D to control the flow of current and density of plasma within the processing region 120. The amount of power applied to the coil antennas 137, 138 also determines the amount of power coupled into the plasma between the substrate and showerhead 122.

During a deposition process, typically a non-silicon-containing gas such as nitrogen, hydrogen, oxygen, nitrous oxide, ammonia, any of the Group VIII noble gases including argon and helium, or like is flowed through each toroidal plasma current path 160-161 through gas inlets 111, 123. Subsequently or simultaneaously, a silicon-containing gas such as Trimethylsilane (TMS), silane, TEOS, or the like is flowed from a gas inlet 117 into the showerhead 122 and then through the showerhead gas dispersion holes 121. Some amount of non-silicon-containing gas may also be mixed with the silicon-containing gas and flowed through the showerhead 122. The gas or the gas mixture entering through the showerhead 122 becomes the process gas and composes the portion of the toroidal plasma loop 160, 161 that is above a substrate placed on the substrate support member 130 to deposit a layer on the substrate surface. As the plasma is generated inductively and externally from the showerhead 122, the amount of power used to dissociate the process gas is not applied with respect to the showerhead 122 and, more importantly, the substrate, which is atop the support member 130. Thus, higher density plasma can thereby be achieved between the showerhead 122 and substrate without directly exposing the substrate to higher energy ion bombardment. This is an important consideration for film deposition applications which are sensitive to ion damage.

During an etching process, typically a non-polymerizing etch gas such as chlorine, boron trichloride, hydrogen chloride, or the like or other gas such as oxygen, any of the Group VIII noble gases including argon and helium or the like is flowed through each toroidal path 160-161 through gas inlets 111, 123, and the same gases or any other etch gas such as carbon tetrafluoride, carbon hexafluoride or like is flowed through the gas inlet 117 into the showerhead assembly 122 and then through the showerhead gas dispersion holes 121. The etch gas dissociates in the plasma to produce an etching species between the showerhead 122 and a substrate placed on the substrate support member 130. As the plasma is generated inductively and externally from the showerhead 122, the amount of power used to dissociate the process gas is not applied with respect to the showerhead 122 and, more importantly, the substrate, which is atop the support member 130. Thus, higher density plasma can thereby be achieved between the showerhead 122 and substrate without directly exposing the substrate to higher energy ion bombardment. This is an important consideration for film etching applications which are sensitive to ion damage.

During a cleaning operation, a cleaning gas such as NF₃ is flowed from the gas inlet 117 into the showerhead 122 and then through the showerhead gas dispersion holes 121. The cleaning gas or additional gas such as hydrogen, any of the Group VIII noble gases including argon and helium, or like may also be flowed to each toroidal plasma current path 160,161 through gas inlets 111, 123. The cleaning gas dissociates in the plasma to produce a cleaning species within the processing region 120. As the power to generate the cleaning species is applied external to the showerhead 122 and substrate support member 130, these parts are protected from damage from ion bombardment from the cleaning species they would otherwise be exposed to if the showerhead 122 and substrate support member 130 were directly powered to generate the cleaning plasma. Furthermore, if the cleaning gas such as NF3 is distributed through the showerhead 122 and an inert gas is flowed through the hollow conduits 124, 125 , the conduit surfaces and the surfaces of the internal passageways of the showerhead 122 will not be exposed to attack from the cleaning gas ions and radicals, and the cleaning gas will not be needlessly “consumed” or neutralized by contact with surfaces that do not have deposits on them.

In another embodiment, some processes may benefit from adding more RF power to the process plasma directly through the showerhead or by adding a RF bias to the substrate support member 130. Whether the process is deposition, etching or cleaning, it is contemplated to apply additional power to the process plasma by driving the showerhead 122 and/or the substrate support member 130 with separate RF power supplies and matching networks.

Although various embodiments which incorporate the teachings of the invention have been shown and described in detail herein, those skilled in the art can readily devise many other varied embodiments within the scope of the invention. For example, only one plasma-shaping apparatus of the first and second plasma-shaping apparatus pair 150A-B, 151A-B and/or magnetic plasma shaping apparatuses 180A-D may be needed to achieve adequate plasma distribution. Furthermore, a plurality of conduits may be used to define multiple toroidal plasma current paths each having at least one plasma-shaping apparatus. Additionally, it is contemplated that only one plasma current path may be used for processing where one set of the plasma shaping apparatus pairs 150A-B and/or magnetic plasma shaping apparatuses 180A-D are adapted to seal one plasma current path. In another aspect, more than one plasma shaping apparatus pairs 150A-B and/or magnetic plasma shaping apparatuses 180A-D may be placed in-line to create different opening patterns. Further, the plasma shaping apparatuses 150A-B, 151A-B and/or magnetic plasma shaping apparatuses 180A-D may be adjusted in-situ to alter the plasma distribution in the process region by making the entire plasma shaping apparatus or some elements of it movable.

In another aspect, it is contemplated that the phase and power of each RF source 115, 127 may be adjusted independently to achieve the desired process plasma energy density distribution within the processing region 120. By selecting various combinations of power and phase of the showerhead RF source 119, the bias RF source 146, and each inductive RF sources 115, 127, the density of the plasma can be controlled over the larger rectangular substrates to overcome non-uniform deposition or etching and/or increase deposition or etch rates.

In another aspect, the showerhead RF source 128 may be used to alter the plasma discharge within the processing region thereby affecting deposition or etching. For example, the RF source 128 may be increased in power to increase the power coupled to the plasma current path adjacent the showerhead 122.

In still another aspect, the RF source 146 is used to alter the deposition or etching process by adjusting the amount and/or energy with which ion species are attracted to the substrate surface. For example, the RF source 146 may be increased in power to increase the ion species attraction to the substrate support member 130.

While foregoing is directed to preferred embodiments of the invention, other and further embodiments of the invention may be devised without departing from the basic scope thereof, and the scope thereof is determined by the claims that follow.

1. An apparatus for substrate processing, comprising:
a chamber comprising a bottom, a top, and a body disposed between the bottom and the top;
a first plasma source disposed about the chamber and defining a first plasma current path therein; and
at least one plasma shaping apparatus disposed adjacent the first plasma current path.

2. The apparatus of claim 1, wherein the first plasma source comprises a hollow member and wherein the at least one plasma shaping apparatus is disposed at one end of the hollow member.

3. The apparatus of claim 1, wherein the first plasma source comprises a pair of outlets wherein each outlet is registered with respective openings formed in opposing sides of the body.

4. The apparatus of claim 3, further comprising a substrate support member having a substrate receiving surface and wherein the respective openings in the opposing sides of the body are at least as wide as the substrate receiving surface.

5. The apparatus of claim 4, further comprising a showerhead connected to the top and in facing relationship with the substrate receiving surface and wherein the respective openings in the opposing sides of the body are disposed between the showerhead and the substrate receiving surface.

6. The apparatus of claim 1, further comprising a second plasma source disposed about the chamber and overlapping at least a portion of the first plasma source, wherein the second plasma source defines a second plasma path therein.

7. The apparatus of claim 6, wherein the first and second plasma sources each define an outlet at each of their respective ends and wherein the outlets of the first plasma source are registered with respective openings formed in a first pair of opposing sides of the body and the outlets of the second plasma source are registered with respective openings formed in a second pair of opposing sides of the body.

8. The apparatus of claim 6, wherein the first and second plasma sources each comprise:
a hollow member, wherein each hollow member defines at least a portion of the respective first and second plasma paths therein.

9. The apparatus of claim 8, further comprising a coil disposed proximate each of the hollow members and adapted to produce a magnetic field therein.

10. The apparatus of claim 8, further comprising at least one other plasma shaping apparatus disposed adjacent the second plasma current path.

11. The apparatus of claim 10, wherein each of the plasma shaping apparatuses are disposed at an outlet of the respective hollow member.

12. The apparatus of claim 1, wherein the first plasma source comprises:
a hollow member defining at least a portion of the first plasma current path therein;
a plenum coupled to each end of the member, wherein each plenum is registered with a respective opening formed in the body.

13. The apparatus of claim 12, wherein the hollow member linearly traverses the top at about a midsection thereof.

14. The apparatus of claim 12, wherein the hollow member comprises at least a short transverse section of insulating member adapted to prevent the formation of a closed electrical path on the hollow member in about a longitudinal direction.

15. The apparatus of claim 12, further comprising a first antenna disposed over the top and adapted to inductively couple energy into the first plasma current path defined within at least a portion of the hollow member.

16. The apparatus of claim 15, wherein the antenna is a coil wound about at least one axis generally orthogonal to the first plasma current path.

17. The apparatus of claim 12, wherein the at least one plasma shaping apparatus is replaceable with one or more plasma shaping apparatus each defining a different geometric plasma shaping opening.

18. The apparatus of claim 1, wherein the at least one plasma shaping apparatus defines a plasma shape opening registered with an outlet of the first plasma source and wherein the plasma shape opening defines at least a first portion and a second portion, wherein the cross-sectional area of the first portion is different than the cross sectional area of the second portion.

19. The apparatus of claim 18, wherein the plasma shaping apparatus comprises a length and width dimension that is greater than the depth dimension.

20. The apparatus of claim 18, wherein the opening is sized about the same width and height as the outlet of the first plasma source and wherein the plasma shape opening define at least two outer portions and at least one inner portion, wherein the at least two outer portions are smaller than the at least one inner portion.

21. The apparatus of claim 1, wherein the at least one plasma shaping apparatus is a magnetic plasma shaping apparatus that provides a magnetic plasma shape opening within the first plasma path.

22. The apparatus of claim 21, wherein the magnetic plasma shaping apparatus comprises at least one magnetic element.

23. The apparatus of claim 20, wherein the at least one magnetic element comprises at least one of magnets, permanent magnets, electromagnets, and combinations thereof.

24. The apparatus of claim 21, wherein the magnetic plasma shaping apparatus position is adjustable relative the plasma.

25. The apparatus of claim 21, wherein the position of the magnetic element is adjustable relative the plasma.

26. A plasma generating system, comprising:
a first hollow member defining a first plasma current path;
a second hollow member defining a second plasma current path and disposed about orthogonal with respect to the first hollow member;
a first RF source disposed along a least a portion of the first hollow member and adapted to produce a first magnetic field within the first hollow member;
a second RF source disposed along a least a portion of the second hollow member and adapted to produce a second magnetic field within the second hollow member;
a first plasma shaping apparatus disposed at one end of the first hollow member; and
a second plasma shaping apparatus disposed at one end of the second hollow member.

27. The system of claim 25, wherein the first and second hollow members are made from a material selected from the group consisting of aluminum, anodized aluminum, stainless steel, ceramic, glass, and combinations thereof.

28. The system of claim 25, wherein the first and second hollow members each have a gas inlet.

29. The system of claim 25, wherein the first pair of plasma shaping apparatus define a first axis and the second pair of plasma shaping apparatus define a second axis substantially orthogonal with respect to the first axis.

30. The system of claim 25, wherein each of the first pair of plasma shaping apparatus are in facing relationship and each of the second pair of plasma shaping apparatus are in facing relationship.

31. The system of claim 25, wherein the first and second pairs of plasma shaping apparatuses define an opening having a width at least equal to a substrate to be processed within a region between the openings defined by the plasma shaping apparatus.

32. The system of claim 25, further comprising:
a substrate support member and a bias RF source coupled to the substrate support member.

33. The system of claim 31, further comprising:
a showerhead and a showerhead RF source coupled to the showerhead.

34. The system of claim 25, wherein the first and second pair of plasma shaping apparatuses each define a plasma shape opening defining a desired plasma density profile therethrough.

35. The system of claim 33, wherein each plasma shape opening defines at least two plasma shaping regions having different geometries from one another.

36. A plasma shaping apparatus, comprising:
a body including an inner surface defining an opening to allow plasma therethrough, wherein the opening has a cross section of varying dimensions to affect plasma current flowing through the opening.

37. The apparatus of claim 35, further comprising an outer vacuum chamber mating surface adapted to mate with a vacuum chamber surface, and a plasma source coupling face adapted to be coupled to a plasma source.

38. The apparatus of claim 35, further comprising an inner face adapted to communicate with a processing region of a vacuum chamber defining the vacuum chamber surface.

39. The apparatus of claim 35, wherein the body is replaceable with one or more other plasma shaping apparatuses each having an opening with a different cross-sectional geometry.

40. The apparatus of claim 35, comprising movable portions which allow the shape of the opening to be changed during a process or between sequential processes to produce a desired plasma distribution in the process region.

41. The apparatus of claim 35, comprising at least one magnetic element defining the inner surface to provide at least one magnetic field to form the opening therein.

42. The apparatus of claim 40, wherein the at least one magnetic element comprises electromagnets, permanent magnets, and combinations thereof.

43. The apparatus of claim 40, wherein the opening is defined by at least one magnetic field wherein the at least one magnetic field is adjusted to define the magnetic opening generally orthogonal to and within the plasma current flow.

44. The apparatus of claim 40, wherein the at least one magnetic element is defined by a first magnetic element disposed adjacent to and juxtaposed a second magnetic element, wherein the magnetic fields generated by the first and second magnetic elements define the at least one magnetic opening.

45. A method of substrate processing, comprising:
flowing a first gas into a first plasma current path defined by a first hollow member located external to a processing region;
applying power to a first antenna adjacent the first hollow member to inductively couple energy into the first gas to form a first plasma current generating a first plasma from the first gas;
flowing the first plasma generating current across the processing region and through another end of the first hollow member to define a first closed plasma current path; and
flowing a process gas through a showerhead into the processing region and forming a plasma of the process gas adjacent a substrate using the first plasma of the first gas.

46. The method of claim 44, wherein the first gas comprises at least one of nitrogen, hydrogen, oxygen, nitrous oxide, any of the Group VIII noble gases including argon and helium, ammonia, chlorine, boron trichloride, hydrogen chloride, and combinations thereof.

47. The method of claim 44, wherein the process gas comprises at least one of a deposition gas, cleaning gas, etch gas, and combinations thereof.

48. The method of claim 44, wherein the process gas comprises Trimethylsilane, silane, disilane, chlorinated silanes, TEOS, H₂, NF₃, Ar, He, and combinations thereof.

49. The method of claim 44, further comprising shaping the plasma current with a first and second plasma shaping apparatus located adjacent each end of the first hollow member.

50. The method of claim 48, wherein flowing the first gas adjacent each of the respective plasma shaping apparatuses comprises flowing the gases through an opening defined by each of the respective plasma shaping apparatuses, wherein each opening defines geometrically differently shaped regions.

51. The method of claim 49, comprising adjusting the geometry of the plasma-shaping apparatuses.

52. The method of claim 49, comprising exchanging one or more of the plasma-shaping apparatuses with one or more plasma shaping apparatuses having different geometrically shaped regions.

53. The method of claim 49, wherein the opening is registered with an outlet of the external plasma source and wherein the plasma shape opening defines a first portion and a second portion, wherein the second portion is narrower than the first portion.

54. The method of claim 48, further comprising flowing a second gas in a second plasma current path defined by a second hollow member located external to the processing region.

55. The method of claim 53, further comprising applying RF power to a second antenna in order to inductively couple energy into the second plasma current path and generating a second plasma from the second gas.

56. The method of claim 54, wherein the first and second gas comprise at least one of nitrogen, hydrogen, oxygen, nitrous oxide, any of the Group VIII noble gases including argon and helium, ammonia, chlorine, boron trichloride, hydrogen chloride, and combinations thereof.

57. The method of claim 54, wherein the first gas and the second gas are the same.

58. The method of claim 54, wherein the process gas comprises at least one of a deposition gas, etch gas, cleaning gas, or combinations thereof.

59. The method of claim 54, wherein the process gas comprises Trimethylsilane, SiH₄, disilane, chlorinated silanes, TEOS, H₂, NF₃, Ar, He, and combinations thereof.

60. The method of claim 54, further comprising flowing the second plasma current adjacent a third plasma shaping apparatus adjacent one end of the second hollow member, and flowing a second plasma current across the processing region and adjacent a fourth plasma shaping apparatus located adjacent another end of the second hollow member to define a second closed plasma current path.

61. The method of claim 58, wherein flowing the first gas and second gas adjacent each of the respective plasma shaping apparatuses comprises flowing the gases through an opening defined by each of the respective plasma shaping apparatuses, wherein each opening defines geometrically differently shaped regions.

62. The method of claim 59, comprising adjusting the geometry of the plasma-shaping apparatuses.

63. The method of claim 59, comprising exchanging one or more of the plasma-shaping apparatuses with one or more plasma shaping apparatuses having different geometrically shaped regions.

64. The method of claim 59, wherein the opening is registered with an outlet of the external plasma source and wherein the plasma shape opening defines a first portion and a second portion, wherein the second portion is narrower than the first portion.

65. The method of claim 48, wherein the plasma shaping apparatus is a magnetic plasma shaping apparatus.

66. The method of claim 63, wherein the plasma-shaping apparatus comprises at least one magnetic field within the opening to shape the plasma within the first plasma current path.

67. The method of claim 64, comprising changing the magnetic field during a process or between sequential processes to shape the plasma.

68. The method of claim 65, wherein the plasma shaping apparatus includes at least one magnetic element and wherein changing the magnetic field comprises adjusting the at least one magnetic element.

69. The method of claim 66, wherein adjusting the magnetic element c6 mprises positioning the magnetic element closer to or further from the plasma.

70. The method of claim 66, wherein the magnetic element is an electromagnet coupled to a current source to induce a magnetic field and wherein adjusting the magnetic element comprises adjusting the current source to increase or decrease the magnetic field.
